(19) United States
(12) Patent Application Publication
(10) Pub. No.: US 2015/0110160 A1
(43) Pub. Date: Apr. 23, 2015

(54) DATA TRANSMISSION METHOD AND APPARATUS

(71) Applicants: Mustafa Gurcan, Southwater, Horsham, West Sussex (GB); Imperial Innovations Limited, South Kensington, London (GB)

(72) Inventor: Mustafa Gurcan, Southwater (GB)

(21) Appl. No.: 14/397,153

(22) PCT Filed: Apr. 26, 2013
(86) PCT No.: PCT/GB2013/000185

§ 371 Date: Oct. 24, 2014

(30) Foreign Application Priority Data
Apr. 27, 2012 (GB) 1207546.1

(51) Int. Cl. H04B 1/7093; H04B 1/7097; H04B 7/04

(52) U.S. Cl. CPC H04B 1/7093; H04B 7/0413; H04B 1/7097
USPC 375/141

(57) ABSTRACT

A method for data transmission in a radio data transmission system having a plurality of parallel single-input single-output or multiple-input multiple-output channels over which the data is transmitted, the data represented by a plurality of data symbols, the data symbols being spread prior to transmission by a plurality of spreading sequences is described. The method comprises determining a system value λk for each signature sequence k of a plurality of signature sequences K, wherein the system value λk is indicative of a signal-to-noise ratio of the associated signature sequence k; determining a number of signature sequences K* to be used for spreading the data symbols in accordance with the system values λk associated with the plurality of signature sequences K, selecting the signature sequences S to be used to spread the data symbols from the plurality of signature sequences K in accordance with the system values λk associated with the plurality of signature sequences K, wherein the number of signature sequences selected corresponds to the determined number of signature sequences K*, and spreading the data symbols using the selected signature sequences S.

### FIELD OF INVENTION

The present invention relates to the field of mobile radio system data transmission. More specifically, but not exclusively, embodiments of the present invention relate to methods for determining spreading sequences to be used to spread data symbols for transmission in a mobile radio system.

### BACKGROUND TO THE INVENTION

Mobile radio system technologies are continuously advancing with a general aim of increasing data rates. The third generation mobile radio system uses a code division multiple access transmission scheme and has been extensively adopted worldwide. The third generation partnership project (3GPP) has developed the high speed down link packet access (HSDPA) system in the Release 5 specification of the Universal Mobile Telecommunications System (UMTS) as a multi-code wide-band code division multiple access (CDMA) system. The success of third generation wireless cellular systems is based largely on the efficient resource allocation scheme used by the HSDPA system to improve the downlink throughput.

With the recent availability of enabling technologies such as adaptive modulation and coding and also hybrid automatic repeat request, it has been possible to introduce internet enabled smart phones for internet-centric applications. The trend for the HSDPA system is to improve the downlink throughput for smart phones with high-data-rate applications. The throughput of the HSDPA downlink has been extensively evaluated. It has been found, in recent years, that the data throughput achievable in practice is significantly lower than the theoretical upper-bound when using the Multiple-Input Multiple-Output (MIMO) HSDPA system.

The downlink throughput optimization for the HSDPA multi-code CDMA system has been considered to be a two part problem. The first problem is that of the signature sequence and power allocation for downlink users. The second problem is the link throughput optimization for a given resource allocation.

The first problem involves the scheduling of users for transmission. This has been extensively examined for downlink transmission. Furthermore, signature sequence design and allocation have been studied in conjunction with power allocation in the context of sum rate maximization for downlink frequency selective channels. It has also been considered how design methods can be utilised to iteratively calculate the transmitter signature sequences and also the mean-square-error (MSE) minimizing receiver despreading filter coefficients. In addition, it has been shown that there exists an optimum set of signature sequences, which maximize the total link throughput for a given set of channel impulse responses between the transmitter and receiver antennas of a MIMO system. Furthermore, systems in which an optimum set of orthogonal signature sequences is identified for a given set of channel impulse responses have been considered.

The use of optimum spreading sequences requires that the channel state information (CSI) should be available both at the transmitter and the receiver. The CSI at the transmitter requires a lot of signaling overhead over both the downlink and the uplink channels. Various methods have therefore been considered to minimize the signaling overhead by enabling each MIMO downlink transmitter antenna to use the same set of orthogonal spreading sequences. An approach was considered by 3GPP and a method was standardized to use a given fixed set size of Orthogonal Variable Spreading Factor (OVSF) spreading sequences. A MIMO system requires a signature sequence set size higher than the given single set of OVSF signature sequences available for each antenna. 3GPP standardized a method which increases the OVSF set size by multiplying the given set with precoding weights and then concatenating the weighted sets of spreading sequences. Each transmission symbol is then spread with a different spreading sequence at each MIMO antenna before transmission. Hence, a unique pre-coded spreading sequence is produced by concatenating the spreading sequences used at each antenna for each transmission symbol. The concatenated spreading sequence is orthogonal to the remaining set of spreading sequences which are available at the transmitter for other transmission symbols. However, the spreading sequence orthogonality is lost at the receiving end after transmission over frequency selective multipath channels. It has been proposed that a linear MMSE equalizer followed by a despreader could be used to restore the orthogonality of the spreading sequences at each receiver and to recover the transmitted symbols after transmission over a multipath channel.

Recent developments have considered a self interference (SI) problem, which is present in linear MMSE equalizers, when operating over multipath channels. In such a problem, the aim is to reduce the large gap between the currently practical achievable rates and the theoretical upper bound for the HSDPA throughput. A receiver with an independent symbol level MMSE equalizer followed by a symbol level successive-interference-cancellation (SIC) scheme deals with the intra-cell self interference. It has been proposed that a hybrid linear equalizer/interference cancelling receiver tailored to the HSDPA standard could be utilised. Furthermore, it has been proposed that use of a SIC receiver in collaboration with either a chip or a symbol level MMSE equalizer for the HSDPA downlink throughput optimization could be used.

The use of a chip level MMSE linear equalizer followed by a despreader and a symbol level SIC is considered to suppress the inter-chip interference (ICI) and also all inter-stream interference. A channel matched filter (CMF) as a linear chip level MMSE equalizer has been shown to maximize the signal-to-noise ratio by collecting the energy at the multipath channel central tap. The chip level equalizer is used to produce an estimate of the transmitted chip sequence which is then despread by one of the transmitter spreading sequences to detect one of the transmitted symbol streams. The recovered symbol is then used to remove the interference iteratively at chip level. Each iteration requires the calculation of the chip level linear equalizer coefficients. The total number of iterations is equal to the number of transmitted data streams.

The use of a receiver with the linear MMSE equalizer and a single stage SIC detector to solve the second downlink throughput maximization problem requires the joint optimization of the transmitter and receiver. Various transmission power allocation schemes can be derived over different data streams for a two stage successive interference cancellation scheme in multi-code MIMO systems. A two stage SIC detection scheme with the transmitter power optimization can improve the throughput performance for multi-code downlink transmission. However, each iteration of the SIC, the equalizer coefficient and the power allocation calculations requires an inversion of a covariance matrix for the received signal. The dimension of the covariance matrix is usually large, and as such the iterative power allocation, the linear MMSE equalizer and the SIC implementations at the receiver become computationally expensive. Simplifications for the inversion of large matrices has been examined to make the implementation of the linear MMSE equalizers followed by the symbol level SIC practically feasible.

Various attempts have been made to attempt to optimise transceiver design. Usually, different optimization criteria are used when allocating powers for the multi-code downlink throughput optimization. Some techniques focus on the transceiver design optimization criteria and others concentrate on criteria for the joint rate and power allocation. Recently, a game theoretic approach has been introduced as an addition to the joint rate and power adaptation methods, which are generalized in L. Zhao and J. Mark, “Joint rate and power adaptation for radio resource management in uplink wideband code division multiple access systems,” IET Communications, vol. 2, no. 4, pp. 562-572, April 2008, under three headings as follows:
1. The first criterion includes the systems which optimize the transmission power to maximize the rate for a given realization of channel gains. A typical example is L. Y. Hoon and K. S. Wu, “Generalized joint power and rate adaptation in ds-cdma communications over fading channels,” IEEE Transactions on Vehicular Technology, vol. 57, no. 1, pp. 603-608, January 2008 which optimizes the number of symbols and the number of bits per symbol. The aim is to maximize the total rate by iteratively adjusting the transmission powers and spreading sequences whilst satisfying a target signal-to-interference-noise (SINR) ratio at each receiver. The transmission power can be iteratively adjusted to meet a target signal-to-noise ratio at each receiver. In addition the total transmission energy for a target signal-to-noise ratio (SNR) can be minimised at the output of each receiver. This type of optimization is known as the margin adaptive loading method. The transmission power and spreading sequences can be optimised to maximize the total rate over multi-code parallel channels, whilst keeping the total transmission power below a given total power constraint. This type of iterative energy allocation is known as the rate adaptive loading method.
2. The second method aims to maintain the received power at a target level, whilst maximizing the total rate by jointly optimizing the transmission power, rate and signature sequences and also the linear MMSE equalizers at the receiver. One example of such a method is S. Ulukus and A. Yener, “Iterative transmitter and receiver optimization for cdma networks,” IEEE Transactions on Wireless Communications, vol. 3, no. 6, pp. 1879-1884, November 2004 which jointly optimizes a set of transmission spreading sequences and receivers with linear MMSE equalizers. The aim is to maximize the throughput or minimize to the mean-square-error at each receiver, when each received signal power level is known to the transmitter.
3. The third method, one example of which is described in L. Zhao and J. Mark, “Joint rate and power adaptation for radio resource management in uplink wideband code division multiple access systems, ” IET Communications, vol. 2, no. 4, pp. 562-572, April 2008, uses the average system performance as an evaluation criterion which requires the distribution of the received and the interference signal powers.

In the first and second adaptation schemes and, in particular, in the margin and rate adaptive loading area it is assumed that the rate and power adaptation is much faster than the changes in the link gains due to users being mobile. In T. Bogale, L. Vandendorpe, and B. Chalise, “Robust transceiver optimization for downlink coordinated base station systems: Distributed algorithm,” IEEE Transactions on Signal Processing., vol. PP, no. 99, p. 1, 2011 a robust margin adaptive loading scheme is examined to minimize the total transmission power subject to per user (or per stream) MSE constraints for a MIMO downlink transmission. A rate adaptive loading scheme is given to maximize the total rate for a given fixed length of spreading sequences. A rate adaptive optimization method is presented in N. Vucic, H. Boche, and S. Shi, “Robust transceiver optimization in downlink multiuser mimo systems,” IEEE Transactions on Signal Processing, vol. 57, no. 9, pp. 3576-3587, September 2009 to minimize the weighted MSE of a downlink MIMO system when considering a constrained total transmission power. A rate adaptive loading scheme is given in T. Bogale, B. Chalise, and L. Vandendorpe, “Robust transceiver optimization for downlink multiuser mimo systems,” IEEE Transactions on Signal Processing, vol. 59, no. 1, pp. 446-453, January 2011 to minimize the weighted MSE with per base station antenna power constraint.

In the current HSDPA system specifications, an equal energy allocation scheme is used to load each channel with either a single rate or two discrete rates. Parameters of the MMSE receivers are usually optimized using either the max-min weighted SINR criterion or the total MSE minimization criterion. Recently, an iterative power adaptation method known as the two-group resource allocation scheme has been developed as described in Z. He, M. Gurcan, and H. Ghani, “Time-efficient resource allocation algorithm over hsdpa in femtocell networks,” in Personal, Indoor and Mobile Radio Communications workshops (PIMRC Workshops), 2010 IEEE 21st International Symposium on, September 2010, pp. 197-202, and Z. He and M. Gurcan, “Optimized resource allocation of hsdpa using two group allocation in frequency selective channel,” in IEEE International Conference on Wireless Communications Signal Processing, 2009. WCSP 2009, November 2009, pp. 1-5. In the method, two distinct discrete bit rates are loaded over the multi-code downlink channels subject to a constrained total transmission power.

Despite of the various developments in this field, the data throughput achieved in practice is still significantly lower than the theoretical upper-bound when using the Multiple-Input Multiple-Output (MIMO) HSDPA system.

### SUMMARY OF INVENTION

Embodiments of the present invention attempt to mitigate at least some of the above-mentioned problems.

In accordance with an aspect of the invention there is provided a method for data transmission in a radio data transmission system having a plurality of parallel single-input single-output or multiple-input multiple-output channels over which the data is transmitted, the data represented by a plurality of data symbols, the data symbols being spread prior to transmission by a plurality of spreading sequences. The method comprises determining a system value λₖ for each signature sequence k of a plurality of signature sequences K, wherein the system value λₖ is indicative of a signal-to-noise ratio of the associated signature sequence k; determining a number of signature sequences K* to be used for spreading the data symbols in accordance with the system values λₖ associated with the plurality of signature sequences K, selecting the signature sequences S to be used to spread the data symbols from the plurality of signature sequences K in accordance with the system values λₖ associated with the plurality of signature sequences K, wherein the number of signature sequences selected corresponds to the determined number of signature sequences K*, and spreading the data symbols using the selected signature sequences S.

The number of sequences K* may be determined and the signature sequences S to be used to spread the symbols may be selected by: calculating the mean system value

$${[ {\vec{λ}}_{mean} ]}_{{K}_{best}} = \frac{{\sum }_{k}^{{K}_{best}} {λ}_{k}}{{K}_{best}}$$

for K_{best}=K to K_{best}=1, wherein K_{best} is an initial number of signature sequences utilised for calculating the mean system value └\vec{λ}ₘₑₐₙ┘_{K}_{_{best}}, and wherein each signature sequence is assigned an equal transmission energy Eₖ for calculating the mean system values └\vec{λ}ₘₑₐₙ┘_{K}_{_{best}}; determining the number of signature sequences K* to be used for spreading the data symbols and selecting the signature sequences S to be used to spread the symbols in accordance with the mean system value vector \vec{λ}ₘₑₐₙ, wherein the mean system value vector \vec{λ}ₘₑₐₙ comprises the plurality of mean system values └\vec{λ}ₘₑₐₙ┘_{K}_{_{best}} for K_{best}1 to K_{best}=K.

The number of signature sequences K* to be used for spreading the data symbols may also be determined to be equal to the initial number of signature sequences K_{best} when the following equation is satisfied:

$${λ}^{*} ( {b}_{{p}_{{K}_{best}}} ) \leq {[ {\vec{λ}}_{mean} ]}_{{K}_{best}} < {λ}^{*} ( {b}_{{p}_{{K}_{best}} + 1} ) .$$

for K_{best}1 to K_{best}=K, wherein └\vec{λ}ₘₑₐₙ┘_{K}_{_{best}} is the mean system value,

$${b}_{{p}_{{K}_{best}}}$$

is a discrete data rate that can be allocated to each data symbol and is chosen from a plurality of data rates from b₁ to bₚ for integer values of p from p=1 to p=P for a plurality of P discrete rates for a target system value λ*(bₚ), the target system value λ*(bₚ) being determined in terms of the data rate bₚ by using the following equation:

$${λ}^{*} ( {b}_{{p}_{k}} ) = \frac{Γ ( {2}^{{b}_{p}} - 1 )}{1 - Γ ( {2}^{{b}_{p}} - 1 )}$$

wherein Γ is the gap value for the modulation scheme and the selected signature sequences S are the K* signature sequences of the plurality of signature sequences K having the highest system values λₖ.

In addition, the number of sequences K* may also be determined and the signature sequences S to be used to spread the symbols may be selected by calculating the minimum system value └\vec{λ}ₘᵢₙ┘_{K}_{ₒₚₜ}=min(\vec{λ}) for Kₒₚₜ=K to Kₒₚₜ=1 wherein Kₒₚₜ is an initial number of signature sequences utilised for calculating the minimum system value └\vec{λ}ₘᵢₙ┘_{K}_{ₒₚₜ}, and each signature sequence is assigned an equal transmission energy Eₖ, determining the number of signature sequences K* and selecting the signature sequences S to be used to spread the data symbols in accordance with the minimum system value vector \vec{λ} ₘᵢₙ comprising a plurality of minimum system values └\vec{λ}ₘᵢₙ┘_{K}_{ₒₚₜ} for Kₒₚₜ=K to Kₒₚₜ=1.

The number of signature sequences K* to be used for spreading the data symbols may also be determined to be equal to the initial number of signature sequences Kₒₚₜ when the following equation is satisfied:

$${λ}^{*} ( {b}_{{p}_{{K}_{opt}}} ) \leq {[ {\vec{λ}}_{min} ]}_{{K}_{opt}} < {λ}^{*} ( {b}_{{p}_{{K}_{opt}} + 1} ) .$$

for Kₒₚₜ=1 to Kₒₚₜ=K, wherein └\vec{λ}ₘᵢₙ┘_{K}_{ₒₚₜ} is the minimum system value,

$${b}_{{p}_{Kopt}}$$

is a discrete data rate that can be allocated to each symbol and is chosen from a plurality of data rates from b₁ to bₚ for integer values of p from p=1 to p=P for a plurality of P discrete rates for a target system value λ*(bₚ), and the selected signature sequences S are the K* signature sequences of the plurality of signature sequences K having the highest system values λₖ.

The method may further comprise ordering, before selecting the signature sequences S, the plurality of signature sequences K from the signature sequence k of the plurality of signature sequences K having the highest system value λₖ to the signature sequence k of the plurality of signature sequences K having the lowest system value λₖ, wherein a high system value λₖ is indicative of a high signal-to-noise ratio, and the selected signature sequences S are the first K* signature sequences of the ordered signature sequence.

In addition, the method may further comprise allocating data rates bₚ_{ₖ} to the plurality of selected signature sequences S in accordance with the system value λₖ, wherein the summation of the allocated data rates bₚ_{ₖ} corresponds to a total data rate per symbol period. The data rates bₚ_{ₖ} may be allocated when determining the number of signature sequences K*.

The total data rate may be determined by finding a maximum integer number m_{EE} that satisfies:

$$( {K}^{*} - {m}_{EE} ) {λ}^{*} ( {b}_{{p}_{{K}^{*}}} ) + {m}_{EE} {λ}^{*} ( {b}_{{p}_{{K}^{*}}} + 1 ) \leq {K}^{*} {⌊ {\vec{λ}}_{m i n} ⌋}_{{K}^{*}}$$

wherein the first group of signature sequences are (K*−m_{EE}) used to transmit data at a discrete data rate bₚ_{_{K*}} and a second group of signature sequences comprising the remaining m_{EE} signature sequences are used to transmit data at a discrete rate

$${b}_{{p}_{{K}^{*}} + 1}$$

for the case corresponding to equal energy allocation.

Furthermore, the total data rate may be determined by finding a maximum integer m_{ES} that satisfies:

$$( {K}^{*} - {m}_{ES} ) {λ}^{*} ( {b}_{{p}_{{K}^{*}}} ) + {m}_{ES} {λ}^{*} ( {b}_{{p}_{{K}^{*}} + 1} ) \leq {K}^{*} {⌊ {\vec{λ}}_{mean} ⌋}_{{K}^{*}}$$

wherein a first group of signature sequences (K*−m_{ES}) are used to transmit data at a discrete data rate bₚ_{_{K*}}, and a second group of signature sequences comprising the remaining m_{ES} signature sequences are used to transmit data at a discrete rate

$${b}_{{p}_{{K}^{*}} + 1} .$$

The method may further comprise allocating transmission energies to the plurality of selected signature sequences K in accordance with the allocated transmission data rate bₚ_{ₖ} and the corresponding system values λₖ to maximize the total data rate per symbol period for the total transmission energy, wherein the summation of the allocated transmission energies corresponds to a total transmission energy E_{T}.

The transmission energies E_{k,i} may be determined iteratively with the following equation based upon a receiver without a successive interference cancellation, SIC, scheme wherein the mean system value is used to determine the number of signature sequences K*:

$${E}_{k , i} = \frac{{λ}^{*} ( {b}_{{p}_{{K}^{*}}} )}{{\vec{q}}_{k}^{H} {C}_{i - 1}^{- 1} {\vec{q}}_{k}}$$

wherein i is the iteration number, Cᵢ₋₁⁻¹ is an inverse covariance matrix which is determined by inverting covariance matrix Cᵢ₋₁, wherein the covariance matrix Cᵢ₋₁ is expressed in terms of an extended matched filter signature sequence matrix Qₑ and an extended amplitude matrix A_{e,(i-1)}=I₃ [symbol] A₍ᵢ₋₁₎ using the following equation Cᵢ₋₁=QₑAₑ₍ᵢ₋₁₎²Qₑ^{H}+2σ²I_{N}_{_{R}}_{(N+l-1)}, wherein [symbol] is the kronecker product and the amplitude matrix A₍ᵢ₋₁)=diag└\sqrt{E_{1,(i-1)}}, \sqrt{E_{2,(i-1)}}, . . . , \sqrt{E_{K*,(i-1)}}┘ is expressed in terms of transmission energies, wherein 2σ² is the noise variance, N_{R} is the number of receiver antennas, N is the processing gain, L is the multipath delay spread length, wherein the extended matched filter receiver sequence matrix Qₑ is expressed in accordance with the following equation Qₑ=[Q,Q₁,Q₂], wherein Q₁ represents the matched filter sequences for the previous symbol period and Q₂ represents the matched filter sequences for the next symbol period, and Q₁ and Q₂ are expressed in accordance with Q₁=└I_{N}_{_{R}} [symbol] (J_{N+L-1}^{T})^{N}┘Q=└\vec{q}_{1,1}, . . . , \vec{q}_{k,1}, . . . \vec{q}_{k*,1}┘ and Q₂=[I_{N}_{_{R}} [symbol] J_{N+L-1}^{N}]Q=└\vec{q}_{1,2}, . . . , \vec{q}_{k,2}, . . . \vec{q}_{k*,2}┘, wherein \vec{q}_{k,1} and \vec{q}_{k,2} are the ISI matched filter sequences for the previous and next symbol periods of the number of signature sequences K*, wherein

$${J}_{N + L - 1} = [ \begin{matrix}{\vec{0}}_{( N + L - 2 )}^{T} & 0 \\ {I}_{N + L - 2} & {\vec{0}}_{N + L - 2}\end{matrix} ]$$

is the shift matrix, wherein the matched filter despreading signature sequence matrix Q=└\vec{q}₁, . . . ,\vec{q}ₖ, . . . \vec{q}_{k*}┘ is determined with the following equation Q=HS, wherein \vec{q}ₖ is the matched filter receiver despreading signature sequence for a plurality of transmission signature sequences S=└\vec{s}₁, . . . ,\vec{s}ₖ, . . . \vec{s}_{k*}┘ of length N wherein H is the MIMO system convolution matrix for a frequency selective multipath channel, wherein the convolution matrix H is expressed in accordance with the following equation

$$H = [ \begin{matrix}{H}^{( 1 , 1 )} & … & {H}^{( 1 , {N}_{T} )} \\ ⋮ & … & ⋮ \\ {H}^{( {N}_{R} , 1 )} & … & {H}^{( {N}_{R} , {N}_{T} )}\end{matrix} ] ,$$

wherein N_{T} is the total number of transmitter antennas, the channel convolution matrix H⁽ⁿ^{ᵣ}^{,n}^{ₜ}⁾ between each pair of receiver antenna nᵣ and transmitter antenna nₜ with channel impulse response vector \vec{h}⁽ⁿ^{ᵣ}^{, n}^{ₜ}⁾=[h₀⁽ⁿ^{ᵣ}^{,n}^{ₜ}⁾, . . . , h_{L-1}⁽ⁿ^{ᵣ}^{,n}^{ₜ}⁾] is expressed in terms of the following equation

$${H}^{( {n}_{r} , {n}_{t} )} = [ \begin{matrix}{\vec{h}}^{( {n}_{r} , {n}_{t} )} & 0 & … & 0 \\ 0 & {\vec{h}}^{( {n}_{r} , {n}_{t} )} & … & ⋮ \\ ⋮ & … & ⋱ & 0 \\ 0 & 0 & … & {\vec{h}}^{( {n}_{r} , {n}_{t} )}\end{matrix} ] .$$

The transmission energies E_{k,i} may also be determined iteratively by solving the following equation based upon a receiver with a successive interference cancellation, SIC, scheme wherein the mean system value is used to determine the number of signature sequences K*:

$${E}_{k , i} = \frac{{γ}^{*} ( {b}_{{p}_{k}} )}{ξ - \frac{{E}_{k , ( i - 1 )} {\vert {ξ}_{3} \vert}^{2}}{1 + {E}_{k , ( i - 1 ) {ξ}_{1}}} - \frac{{E}_{k , ( i - 1 )} ( \begin{matrix}{\vert {ξ}_{4} \vert}^{2} - 2 \frac{{E}_{k , ( i - 1 )}}{1 + {E}_{k , ( i - 1 )} {ξ}_{1}} {ξ}_{6} + \\ {( \frac{{E}_{k , ( i - 1 )}}{1 + {E}_{k , ( i - 1 )} {ξ}_{1}} )}^{2} {\vert {ξ}_{5} \vert}^{2} {\vert {ξ}_{3} \vert}^{2}\end{matrix} )}{1 + {E}_{k} ( {ξ}_{2} - \frac{{E}_{k , ( i - 1 )}}{1 + {E}_{k , ( i - 1 )} {ξ}_{1}} {\vert {ξ}_{5} \vert}^{2} )}}$$

for a given inverse covariance matrix Cₖ₋₁⁻¹ wherein the inverse matrix Cₖ₋₁⁻¹ is the inverse of the covariance matrix Cₖ₋₁ wherein the covariance matrix Cₖ₋₁ is iteratively determined by solving the following equation:

Cₖ=Cₖ₋₁+Eₖ\vec{q}ₖ\vec{q}ₖ^{H}+Eₖ\vec{q}_{k,1}\vec{q}_{k,1}^{H}+Eₖ\vec{q}_{k,2}\vec{q}_{k,2}^{H}

for k=1, . . . , K* when using C₀=2σ²I_{N}_{_{R}}_{(N+L-1)}, wherein the target SNR γ*(bₚ_{ₖ}) is determined by using the following equation:

$${γ}_{k}^{*} ( {b}_{{p}_{k}} ) = Γ ( {2}^{{b}_{{p}_{k}}} - 1 ) ,$$

the weighting factors ξ, ξ₁, ξ₂, ξ₃, ξ₄, ξ₅, and ξ₆ are constructed from the SIC receiver covariance matrix Cₖ₋₁⁻¹ and \vec{q}ₖ, \vec{q}_{k,1} and \vec{q}_{k,2} using

ξ=\vec{q}ₖ^{H}\vec{d}, ξ₁=\vec{q}_{k,1}^{H}\vec{d}₁, ξ₂=\vec{q}_{k,2}^{H}\vec{d}₂,

ξ₃=\vec{q}ₖ^{H}\vec{d}₁, ξ₄=\vec{q}ₖ^{H}\vec{d}₂, ξ₅=\vec{q}_{k,1}^{H}\vec{d}₂, ξ₆=Real(ξ₃ξ*₄ξ₅);

wherein the distance vectors \vec{d}, \vec{d}₁, \vec{d}₂ are determined using the following equations

\vec{d}=Cₖ₋₁⁻¹\vec{q}ₖ,\vec{d}₁=Cₖ₋₁⁻¹\vec{q}_{k,1},\vec{d}₂=Cₖ₋₁⁻¹\vec{q}_{k,2}.

For an inverse covariance matrix

$${C}_{k - 1}^{- 1} with {C}_{0}^{- 1} = \frac{1}{2 {σ}^{2}} {I}_{{N}_{R} ( N + L - 1 )} ,$$

and also for an energy allocation Eₖ and a set of MIMO system parameters with \vec{q}ₖ, \vec{q}_{k,1} and \vec{q}_{k,2},Eₖ, σ², the inverse covariance matrix Cₖ⁻¹ may be constructed for k=1, . . . , K* starting at k=1 using the inverse covariance matrix Cₖ₋₁⁻¹ and the energy Eₖ by determining the distance vectors, \vec{d}, \vec{d}₁ and \vec{d}₂, determining the weighting factors ξ, ξ₁, ξ₂, ξ₃ξ₄, ξ₅, and ξ₆, and determining the weighted energy terms and ζ₁, and ζ₂ by using the allocated energy Eₖ for k=1, . . . , K* in the following equations:

$${ζ}_{1} = \frac{{E}_{k}}{1 + {E}_{k} {ξ}_{1}} , \\ {ζ}_{2} = \frac{{E}_{k}}{1 + {E}_{k} ( {ξ}_{2} - {ζ}_{1} {\vert {ξ}_{5} \vert}^{2} )} ;$$

determining the interim matrices Z₁, Z₂, Z₃ by solving the following equations:

Z₁=\vec{d}₁\vec{d}₁^{H}, Z₂=\vec{d}₂\vec{d}₂^{H}, Z₃=\vec{d}₁\vec{d}₂^{H};

determining the inverse reduced covariance matrix Dₖ⁻¹ by solving the following equation:

Dₖ⁻¹=Cₖ₋₁⁻¹−(ζ₁²ζ₂|ξ₅|²+ζ₁)Z₁−ζ₂Z₂+ζ₁ζ₂(ξ₅Z₃+ξ*₅Z₃^{H}); and

constructing the inverse of the covariance matrix Cₖ⁻¹ by using the following equation:

Cₖ⁻¹=Dₖ⁻¹−ζZ₄;

wherein the weighted energy term ζ is determined by solving the following equation:

$$ζ = \frac{{E}_{k}}{1 + {E}_{k} ( ξ - \frac{{E}_{k} {\vert {ξ}_{3} \vert}^{2}}{1 + {E}_{k} {ξ}_{1}} - \frac{{E}_{k} ( \begin{matrix}{\vert {ξ}_{4} \vert}^{2} - 2 \frac{{E}_{k}}{1 + {E}_{k} {ξ}_{1}} {ξ}_{6} + \\ {( \frac{{E}_{k}}{1 + {E}_{k} {ξ}_{1}} )}^{2} {\vert {ξ}_{5} \vert}^{2} {\vert {ξ}_{3} \vert}^{2}\end{matrix} )}{1 + {E}_{k} ( {ξ}_{2} - \frac{{E}_{k}}{1 + {E}_{k} {ξ}_{1}} {\vert {ξ}_{5} \vert}^{2} )} )} , ;$$

wherein the interim matrix Z₄ is determined by using the following equation:

Z₄=\vec{d}₃\vec{d}₃^{H}; and

wherein the distance vector \vec{d}₃ is determined using the following equation:

\vec{d}₃=Dₖ⁻¹\vec{q}ₖ.

The number of signature sequences K* may be determined and the signature sequences S to be used to spread the data may be selected using an iterative water-filling based continuous bit loading method comprising determining the number of signature sequences K* by determining the total number of signature sequences that maximize the total data rate b_{T,K}.

For a plurality of matched filter signature sequences \vec{q}ₖ, \vec{q}_{k,1} and \vec{q}_{k,2}, the iterative water-filling optimisation method may further comprise setting an initial number of signature sequences Kₒₚₜ, determining the system values λₖ associated with the initial number of signature sequences Kₒₚₜ, determining a channel SNR vector \vec{g} using the following equation:

$${[ {g}^{->} ]}_{k} = \frac{{λ}_{k}}{{E}_{k} ( 1 - {λ}_{k} )} ;$$

for an energy allocation Eₖ, determining a water filling constant K_{WF} using the following equation:

$${K}_{WF} = \frac{1}{{K}_{opt}} ( {E}_{T} + Γ {\sum }_{k = 1}^{{K}_{opt}} \frac{1}{{[ {g}^{->} ]}_{k}} ) ;$$

wherein E_{T} is a total transmission energy, determining energies Eₖ to be allocated to each signature sequence k of the plurality of signature sequences K by using the following equation:

$${E}_{k} = {K}_{WF} - \frac{Γ}{{[ \vec{g} ]}_{k}}$$

reordering the matched filter signature sequences \vec{q}ₖ, \vec{q}_{k,1} and \vec{q}_{k,2} in accordance with the system values └\vec{λ}┘ₖ=λₖ associated with the initial number of signature sequences Kₒₚₜ in an ascending order to provide an ordered list of matched filter signature sequences, deleting the first matched filter sequences \vec{q}₁, \vec{q}_{1,1} and \vec{q}_{1,2} of the ordered list of matched filter signature sequences, and setting Kₒₚₜ=Kₒₚₜ−1 if the allocated energy E₁ is negative, repeating the above steps, determining a total number of bits b_{T,K} to be transmitted by using:

$${b}_{T , k} = {\sum }_{k = 1}^{{K}_{opt}} {log}_{2} ( 1 + \frac{{λ}_{k}}{Γ ( 1 - {λ}_{k} )} ) ;$$

determining the number of signature sequences K* of the plurality of signature sequences K under consideration by using K*=Kₒₚₜ.

The iterative water filling method may determine the number of signature sequences K* by initially setting the total number of signature sequences K*=K, determining a total data rate to be transmitted and the number of signature sequences K* for values of K*=K−1 until the number of signature sequences K* reaches the value K*=1, and selecting the number of signature sequences K* for the plurality of signature sequences K which maximises the total data rate.

The system value may be determined by the following equation:

λₖ=γₖεₖ

wherein γₖ is the signal-to-noise ratio at an output of a de-spreading unit of an MMSE receiver, and εₖ is the mean-square-error at the output of the de-spreading unit, the mean-square-error relating to the system value by λₖ=1−εₖ.

Furthermore, the system value λₖ may be determined in accordance with the following equation based upon a receiver without a successive interference cancelling, SIC, scheme:

λₖ=Eₖ\vec{q}ₖ^{H}C⁻¹\vec{q}ₖ

wherein C is expressed in terms of the extended matched filter signature sequence matrix Qₑ and the extended amplitude matrix Aₑ=I₃ [symbol] A using the following equation C=QₑAₑ²Qₑ^{H}+2σ²I_{N}_{_{R}}_{(N+l-1)} wherein [symbol] is the kronecker product and the amplitude matrix A=diag└\sqrt{E₁}, \sqrt{E₂}, . . . , \sqrt{E_{k*}}┘, wherein the matched filter despreading signature sequence matrix Q=└\vec{q}₁, . . . , \vec{q}ₖ, . . . \vec{q}_{K*}┘ is formed to construct the extended matched filter signature sequence matrix Qₑ by using the following equation Qₑ=[Q, Q₁, Q₂], wherein Q₁ represents the matched filter sequences for the previous symbol period and Q₂ represents the matched filter sequences for the next symbol period, wherein Q₁ and Q₂ are expressed in accordance with the following equations Q₁=└I_{N}_{_{R}} [symbol] (J_{N+L-1}^{T})^{N}┘Q=[\vec{q}_{1,1}, . . . , \vec{q}_{k,1}, . . . \vec{q}_{K*,1}]and Q₂=[I_{N}_{_{R}} [symbol] J_{N+L-1}^{N}]Q=└\vec{q}_{1,2}, . . . , \vec{q}_{k,2}, . . . \vec{q}_{k*,2}┘, wherein \vec{q}_{k,1} and \vec{q}_{k,2} are the ISI matched filter sequences for the previous and next symbol periods.

The system value λₖ may also be determined in accordance with the following equation based upon a receiver having a successive interference cancelling, SIC, scheme:

λₖ=Eₖ\vec{q}ₖ^{H}Cₖ⁻¹\vec{q}ₖ

wherein Cₖ₋₁ is a covariance matrix which is iteratively determined by solving the following equation:

Cₖ=Cₖ₋₁+Eₖ\vec{q}ₖ\vec{q}ₖ^{H}+Eₖ\vec{q}_{k,1}\vec{q}_{k,1}^{H}+Eₖ\vec{q}_{k,2}\vec{q}_{k,2}^{H}

for k=1, . . . , K* when using C₀=2σ²I_{N}_{_{R}}_{(N+L-1)} wherein \vec{q}_{k,1} and \vec{q}_{k,2} are the ISI matched filter sequences for the previous and next symbol periods and \vec{q}ₖ is the matched filter despreading signature sequence.

In accordance with another aspect of the invention apparatus is provided which is arranged to perform any of the methods described above. The apparatus may be a radio transmission base station.

In accordance with yet another aspect of the invention a computer readable medium is provided which is implementable on a computer and operable, in use, to perform any of the methods described above.

Embodiments of the invention provide a system model for the HSDPA MIMO system which is extended to model successive interference cancellation schemes. The scheme may be integrated with an iterative covariance matrix inversion method. This simplifies the inversions of covariance matrices. Such a method can be used iteratively to calculate the transmission energies and to allocate transmission data rates for each parallel channel in a given HSDPA MIMO system.

Embodiments of the invention provide a novel method to obtain the transmission bit rates before allocating the transmission energies. The allocated rates can be used in conjunction with the iterative covariance matrix inversions to calculate the transmission energies whilst optimizing the sum capacity for a given total transmission energy. The sum capacity can be improved by dynamically changing the number of spreading sequences. This scheme requires both the identification of the optimum transmission numbers and also the spreading sequences to be used for a given transmission channel convolution matrix between the MIMO transmitter and receiver antennas.

Embodiments of the invention provide two different algorithms to find the optimum number of spreading sequences using the previously developed two group equal SNR algorithm and the equal energy allocation schemes.

Embodiments of the invention achieve a performance close to the system value upper bound, when using the proposed optimum number of spreading schemes and the spreading sequence selection scheme.

Embodiments of the invention provide a receiver with a symbol level linear MMSE equalizer followed by a single level SIC detector. Embodiments of the invention optimize the transmission power and the receiver for a single-user multi-code downlink transmission system. The receiver can advantageously suppress the ICI and ISI interferences iteratively without the need to invert a large covariance matrix for each iteration for multi-code downlink transmission over frequency selective channels.

Embodiments of the invention also provide an iterative transmission power/energy adaptation scheme to maximize the sum capacity of the downlink for a single user, when using discrete transmission rates and a constrained total transmission power.

Embodiments of the invention utilise an energy adaptation criterion known as the system value optimization criterion to maximize the total rate. The system value approach is a modified version of the total mean-square-error (MMSE) minimization criterion.

In embodiments of the invention the power/energy adaptation method is implemented iteratively without focusing either on the distribution of the received and interference powers or maintaining each destination's received signal power at a target level. The method can maximize the total transmission rate by optimizing the power allocated to each channel to maintain the signal-to-noise-ratio at desired target levels using the linear MMSE and the SIC receiver.

In accordance with embodiments of the invention a system utilising a MIMO transmitter and receiver and multiple spreading sequences is considered. Data symbols may be spread using a plurality of spreading sequences prior to transmitting over a frequency selective multipath channel. At the receiver each spreading sequence \vec{s}ₖ may have an associated system value λₖ which is indicative of the signal to noise ratio γₖ at a receiver. The system value λₖfor each spreading sequence may depend on the transmission multipath channel. As such, the transmission system optimization disclosed herein may retain the spreading sequences with the highest system values and identify the number of spreading sequences to be used for a given total received signal-to-noise ratio corresponding to a given total transmission energy E_{T}.

### BRIEF DESCRIPTION OF THE DRAWINGS

Exemplary embodiments of the invention shall now be described with reference to the drawings in which:

FIG. 1 provides a schematic illustration of an HSDPA MIMO transmitter and receiver arrangement; and

FIG. 2 provides a schematic illustration of a Successive Interference Cancelling receiver.

Throughout the description and the drawings, like reference numerals refer to like parts.

### SPECIFIC DESCRIPTION

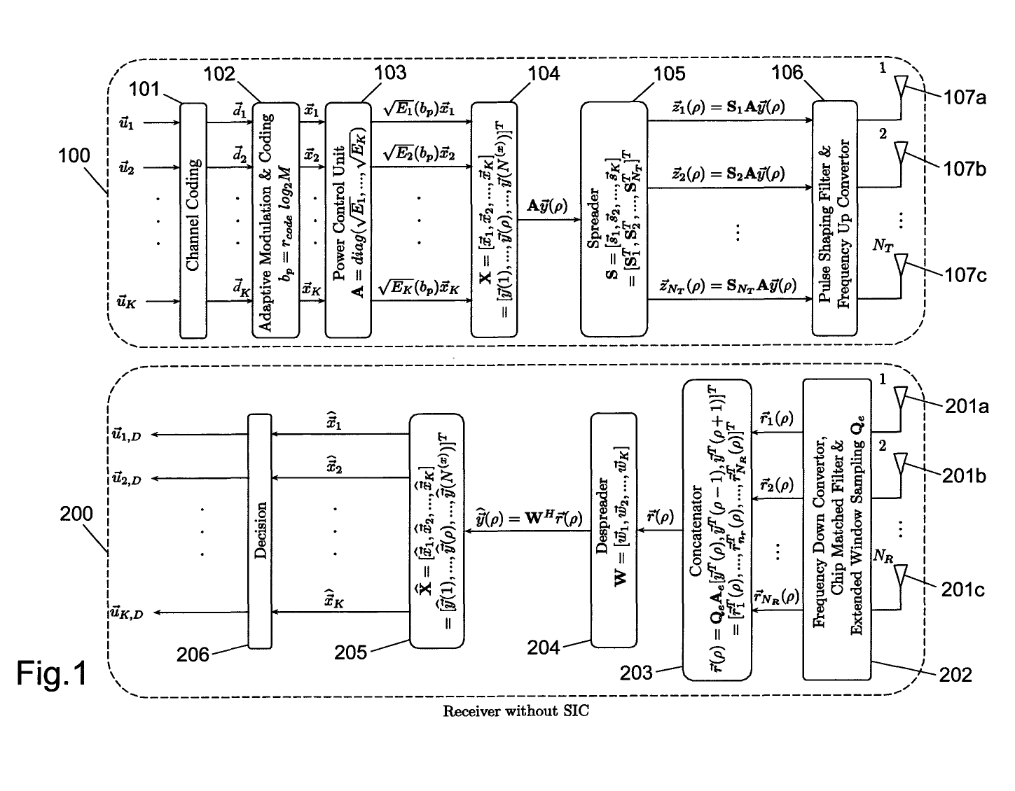

A first embodiment of the invention shall now be described with reference to FIG. 1.

In FIG. 1, a transmitter 100 receives input vectors of \vec{u}ₖ for k=1, . . . , K* and this input data is encoded and mapped into encoding unit 101. The encoded data \vec{d}ₖ for k=1, . . . , K* produced by the encoding unit 101 is then processed by the adaptive modulation and coding unit 102 to transform the encoded data into symbol vectors \vec{x}ₖ=[xₖ(1), . . . , xₖ(ρ), . . . , xₖ(N^{(x)})]^{T} for each channel k =1, . . . , K*. The transmission symbol energies are then adjusted using the power control unit 103. The energy weighted data symbols are transformed into a transmitted vector A\vec{y}(ρ)=A[y₁(ρ), . . . , yₖ(ρ), . . . , y_{k*}(ρ)]^{T} containing the weighted symbols over the symbol period ρ=1, . . . , N^{(x)} using the vector generation unit of 104. The data symbols are then spread by a plurality of spreading sequences in the spreading unit 105. The spread symbols are next filtered using the pulse shaping filter 106 to produce transmission signals for transmission from the MIMO transmitters 107a, 107b, . . . , 107N_{T}.

The transmitted signal is then received at the receiver 200 by the MIMO receivers 201a, 201b, . . . , 201N. The received signal is then frequency down converted, filtered and sampled at chip period intervals by the chip matched filter unit 202. The sampled data vectors are then concatenated by the vector concatenation unit 203 and despread by the despreading unit 204 using the de-spreading sequences to estimate the transmitted data symbols for each symbol period. The estimated data symbols are then reorganised to produce the estimated data for each spreading sequence using the receiver vector mapping unit 205, and the decision unit 206.

Each of the above-mentioned units of the transmitter and receiver, apart from the actual MIMO transmitters 107a, 107b, . . . , 107N and receivers 201a, 201b, . . . , 201N are implemented in software.

The system of this embodiment of the invention is designed to determine which spreading sequences can be used in the above-mentioned data transmission apparatus in order to improve the overall data rate achievable by the system. Embodiments of the invention are based around the principle of utilising a system value in order to determine which spreading sequences should be utilised for the spreading by the spreading unit 105 in order to increase the achievable data rates.

The system value is a variable which is indicative of the characteristics of the channel over which the data is to be transmitted. The system value is the normalized usable signal energy at the output the de-spreading unit. The difference between the normalised total energy of unity and the system value gives the mean square error at the output of the de-spreading unit. The ratio of the normalised energy, the system value, to the mean square error gives the signal-to-noise ratio at the output of the de-spreading unit. Hence, the system value is indicative of a signal to noise ratio over the channel.

The system value allows for a determination to be made regarding which spreading sequences will be stronger and which will be weaker given the characteristics of the transmission channel. As such, weaker spreading sequences can be excluded from the transmission process, and consequently only the stronger spreading sequences are utilised to spread the data symbols, and therefore increased data rates are achieved.

The determination of the system value in accordance with the first embodiment of the invention is set-out below.

In this embodiment of the invention a multi-code CDMA downlink system as shown in FIG. 1 with a total of N_{T} and N_{R} transmitter and receiver antennas and also K spreading sequences, each of which is realizable with a bit rate of bₚ_{ₖ} bits per symbol from a set of bit rates,

$$, {\{ {b}_{{p}_{k}} \}}_{{p}_{k} = 1}^{P} ,$$

for a given total energy E_{T} and p=1,2, . . . , P is considered.

By excluding the weak channels corresponding to a specific set of spreading sequences, the number of parallel transmission channels is reduced to K* spreading sequences to transmit a symbol per channel. The data for the intended symbol for each channel is placed in an (N_{U}×1)-dimensional vector \vec{u}ₖ for k=1, . . . , K* . Each of these data packets is then channel encoded to produce a (B×1)-dimensional vector \vec{d}ₖ and mapped to symbols using a quadrature amplitude modulation scheme (QAM) with M constellations to transmit data at a rate b=log₂M bits per symbol. The channel encoder rate is

$${r}_{code} = \frac{{N}_{U}}{B}$$

and the realizable discrete rates are given by bₚ=r_{code}log₂M for p=1, . . . , P where P is the number of available discrete data rates.

Data is transmitted in packets at a transmission-time-interval (TTI) and the number of symbols transmitted per packet is denoted as N^{(x)} where

$${N}^{( x )} = \frac{TTI}{{NT}_{c}}$$

and N is the spreading sequence length, T_{c} is the chip period and NT_{c} is the symbol period. The transmission symbols, corresponding to each vector \vec{d}ₖ over the period ρ=1, . . . , N^{(x)} are used to produce the (N^{(x)}×1)-dimensional symbol vector \vec{x}ₖ=[xₖ(1), . . . , xₖ(ρ), . . . , xₖ(N^{(x)})]^{T} for each channel k=1, . . . , K*. The entire block of transmission can be represented as an (N^{(x)}×K*) dimensional transmit symbol matrix defined as:

$$\begin{matrix}X = ⌊ {{x}^{->}}_{1} , ⋯ , {{x}^{->}}_{k} , ⋯ , {{x}^{->}}_{{K}^{*}} ⌋ & ( 1 ) \\ = {[ {y}^{->} ( 1 ) , ⋯ , {y}^{->} ( ρ ) , ⋯ {y}^{->} ( {N}^{( x )} ) ]}^{T} . & ( 2 )\end{matrix}$$

The transmitted vector \vec{y}(ρ)=[y₁(ρ), . . . , yₖ(ρ), . . . , y_{K*}(ρ)]^{T} contains the symbols, over the symbol period ρ=1, . . . , N^{(x)}, with the unit average energy E└yₖ(ρ)y*ₖ(ρ)┘=1 for k=1, . . . , K*.

Power allocation is performed on the symbols before spreading. The energies for all K* channels are stored in an amplitude matrix A=diag(\sqrt{E₁}, . . . , \sqrt{Eₖ}, . . . , \sqrt{E_{k*}}) subject to the total energy E_{T} such that Σₖ₌₁^{k*}Eₖ≦E_{T}.

After assigning energies, the amplitude weighted symbols are spread with N×K* dimensional spreading sequences Sₙ_{ₜ}=[\vec{s}ₙ_{ₜ}_{,1}, . . . \vec{s}ₙ_{ₜ}_{,k}, \vec{s}ₙ_{ₜ}_{,K*}], for n₁=1, . . . , N_{T}. For a MIMO system with a total of N_{T} transmitter antennas the signature sequence matrix of N_{T}N×K* is formed as:

$$S = [ {\vec{s}}_{1} , … , {\vec{s}}_{{K}^{*}} ] = {[ {S}_{1}^{T} , … , {S}_{{n}_{t}}^{T} , … {S}_{{N}_{T}}^{T} ]}^{T} \qquad ( 3 )$$

where |\vec{s}ₖ|²=1. At every symbol period ρ=1, . . . , N^{(x)} the length N transmit vector:

$${\vec{z}}_{{n}_{t}} ( ρ ) = {⌊ {z}_{{n}_{t} , 1} ( ρ ) , … , {z}_{{n}_{t} , N} ( ρ ) ⌋}^{T} = {S}_{{n}_{t}} A \vec{y} ( ρ ) \qquad ( 4 )$$

is generated at the input of nₜ^{th} antenna for nₜ=1, . . . , N_{T}. Each element of vector \vec{z}ₙ_{ₜ}(ρ) is fed to a pulse shaping filter at integer multiples of the chip period T_{c} prior to being modulated using an up converter modulator to transmit the spread signal at the desired transmission carrier frequency using the nₜ^{th} transmitter antenna.

At each TTI, pilot signals estimate the channel condition at each receiver and feed the estimates back to the transmitter. It is assumed that the channel condition does not change for that TTI. All symbols in block N^{(x)} in all spread sequence channels from the nₜ^{th} transmitter antenna to the nᵣ^{th} receiver antenna experience the same channel condition in multipath environment with L resolvable paths. This can be represented by a channel impulse response function \vec{h}⁽ⁿ^{ᵣ}^{,n}^{ₜ}⁾=[h₀⁽ⁿ^{ᵣ}^{,n}^{ₜ}⁾ . . . h_{L-1}⁽ⁿ^{ᵣ}^{,n}^{ₜ}⁾]^{T} and its corresponding ((N+L−1)×N)-dimensional channel convolution matrix H⁽ⁿ^{ᵣ}^{,n}^{ₜ}⁾ as follows:

$${H}^{( {n}_{r} , {n}_{t} )} = [ \begin{matrix}{h}_{0}^{( {n}_{r} , {n}_{t} )} & 0 & & 0 \\ ⋮ & {h}_{0}^{( {n}_{r} , {n}_{t} )} & & ⋮ \\ {h}_{L - 1}^{( {n}_{r} , {n}_{t} )} & ⋮ & ⋱ & 0 \\ 0 & {h}_{L - 1}^{( {n}_{r} , {n}_{t} )} & & {h}_{0}^{( {n}_{r} , {n}_{t} )} \\ ⋮ & ⋮ & ⋱ & ⋮ \\ 0 & 0 & & {h}_{L - 1}^{( {n}_{r} , {n}_{t} )}\end{matrix} ] . \qquad ( 5 )$$

The overall (N_{R}(N+L−1)×N_{T}N)-dimensional MIMO channel convolution matrix can be formed as:

$$H = [ \begin{matrix}{H}^{( 1 , 1 )} & ⋯ & {H}^{( 1 , {N}_{T} )} \\ ⋮ & ⋱ & ⋮ \\ {H}^{( {N}_{R} , 1 )} & ⋯ & {H}^{( {N}_{R} , {N}_{T} )}\end{matrix} ] . \qquad ( 6 )$$

At the receiver, the resultant multipath causes the despreading signature sequences to be longer than the spreading signature sequences at the transmit antenna as the channel impulse response convolves with the transmitter signature sequences S. The N_{R}(N+L−1)×K* dimensional receiver matched filter signature sequence matrix is obtained as:

Q=HS=[\vec{q}₁, . . . \vec{q}ₖ, . . . \vec{q}_{K*}] (7)

where the N_{R}(N+L−1)-dimensional vector \vec{q}ₖ=H\vec{s}ₖ is the receiver matched filter despreading sequence. This causes inter-symbol-interference and inter-code interference. At the receiver, the ISI can be dealt with by forming the N_{R}(N+L−1)×3K* dimensional extended matched filter matrix:

Qₑ└Q,└I_{N}_{_{R}} [symbol] (J^{T})^{N}┘Q, [I_{N}_{_{R}} [symbol] J^{N}]Q┘ (8)

where the signature sequence matrices ØI_{N}_{_{R}} [symbol] (J^{T})^{N}┘Q=└I_{N}_{_{R}} [symbol] (J^{T})^{N}┘HS and └I_{N}_{_{R}} [symbol] J^{N}┘Q=└I_{N}_{_{R}} [symbol] J^{N}┘HS are expressed as:

Q₁=└I_{N}_{_{R}} [symbol] (J^{T})^{N}┘HS=[\vec{q}_{1,1}, . . . \vec{q}_{k,1}, . . . \vec{q}_{k*,1}] and (9)

Q₂=└I_{N}_{_{R}} [symbol] J^{N}┘HS=[\vec{q}_{1,2}, . . . \vec{q}_{k,2}, . . . \vec{q}_{k*,2}] (10)

Both \vec{q}_{k,1}=└I_{N}_{_{R}} [symbol] (J^{T})^{N}┘\vec{q}ₖ and \vec{q}_{k,2}=└I_{N}_{_{R}} [symbol] J^{N}┘\vec{q}ₖ are the receiver signature sequences corresponding to the previous and the next symbol periods and are used to handle the ISI. The (N+L−1)×(N+L−1)-dimensional matrix is defined as

$${J}_{N + L - 1} = [ \begin{matrix}{{0}^{->}}_{( N + L - 2 )}^{T} & 0 \\ {I}_{( N + L - 2 )} & {{0}^{->}}_{( N + L - 2 )}\end{matrix} ] .$$

For simplicity the subscript will be dropped from the J matrix notation. When the matrix J^{N} operates on a column vector, it downshifts the column by N chips filing the top of the column with N zeros. Assuming the clocks at the transmitter and receiver are fully synchronized, the received signals are first down converted to the baseband. The signals at the output of each receiver chip matched filter is sampled at the chip period intervals T_{c}. The chip matched filter at the nᵣ^{th} receiver has a total of (N+L−1) samples \vec{r}ₙ_{ᵣ}(ρ)=[rₙ_{ᵣ}_{,1}(ρ) . . . rₙ_{ᵣ}_{,(N+L-1)}(ρ)]^{T} to be processed for the symbol period of ρ. The nᵣ^{th} received signal matrix is given as Rₙ_{ᵣ}=└\vec{r}ₙ_{ᵣ}(1), . . . , \vec{r}ₙ_{ᵣ}(ρ), . . . \vec{r}ₙ_{ᵣ}(N^{(x)})┘. The received matched filter containing all antenna elements at a symbol period is given by the vector \vec{r}(ρ)=[\vec{r}₁^{T}(ρ), . . . , \vec{r}ₙ_{ᵣ}^{T}(ρ), . . . , \vec{r}_{N}_{_{R}}^{T}(ρ)]^{T} of size N_{R}(N+L−1) for ρ=1, . . . , N^{(x)}−1. The received signal vector over the symbol period, ρ, is given in terms of the transmitter vector \vec{y}(ρ) as:

$${r}^{->} ( ρ ) = {Q}_{e} ( {I}_{3} ⊗ A ) [ \begin{matrix}{y}^{->} ( ρ ) \\ {y}^{->} ( ρ - 1 ) \\ {y}^{->} ( ρ + 1 )\end{matrix} ] + {n}^{->} ( ρ ) \qquad ( 11 )$$

where [symbol] is the Kronecker product and the N_{R}(N+L−1) dimensional noise vector \vec{n}(ρ) has the noise covariance matrix E[\vec{n}(ρ)\vec{n}^{H}(ρ)]=2σ²I_{N}_{_{R}}_{(N+L-1)} with the one dimensional noise variance

$${σ}^{2} = \frac{{N}_{0}}{2} .$$

The N_{R}(N+L−1)×N^{(x)} dimensional received signal matrix for the MIMO receiver is given as R=[\vec{r}(1), . . . , \vec{r}(ρ), . . . \vec{r}(N^{(x)})]=[R₁^{T}, . . . , R₁ₜ_{ᵣ}^{T}, . . . R_{N}_{_{R}}^{T}]^{T}.

The received signal vector \vec{r}(ρ) over the symbol period, ρ, is used to produce the size K* column vector \vec{ŷ}(ρ)=[\vec{ŷ}₁(ρ), . . . , \vec{ŷ}ₖ(ρ), . . . , \vec{ŷ}_{K*}(ρ)]^{T} as an estimate of the transmitted symbol vector \vec{y}(ρ) using \vec{ŷ}(ρ)=W^{H}\vec{r}(ρ).

The N_{R}(N+L−1)×K* dimensional matrix w=[\vec{w}₁, . . . , \vec{w}ₖ, . . . , \vec{w}_{k*}] has the MMSE linear equalizer despreading filter coefficients \vec{w}ₖ for k=1, . . . , K*. In order to ensure that \vec{w}ₖ^{H}\vec{q}=1 and the cross-correlations \vec{w}ₖ^{H}\vec{q}ⱼ are minimized for j≠k, a normalized MMSE despreading filter coefficient vector is given by:

$$\begin{matrix}{{w}^{->}}_{k} = \frac{{C}^{- 1} {{q}^{->}}_{k}}{{{q}^{->}}_{k}^{H} {C}^{- 1} {{q}^{->}}_{k}} with & ( 12 ) \\ C = {Q}_{e} ( {I}_{3} ⊗ {A}^{2} ) {Q}_{e}^{H} + 2 {σ}^{2} {I}_{{N}_{R} ( N + L - 1 )} & ( 13 )\end{matrix}$$

Where C=E[\vec{r}(ρ)\vec{r}^{H}(ρ)] is the N_{R}(N+L−1)×N_{R}(N+L−1) dimensional covariance matrix of the received signal vector \vec{r}(ρ). The covariance matrix C, given in (13), can be iteratively calculated using:

Cₖ=Cₖ₋₁+Eₖ\vec{q}ₖ\vec{q}ₖ^{H}+Eₖ\vec{q}_{k,1}\vec{q}_{k,1}^{H}+Eₖ\vec{q}_{k,2}\vec{q}_{k,2}^{H} (14)

for k=1, . . . , K* when using C₀=2ρ²I_{N}_{_{R}}_{(N+L-1)} and C=C_{K*}.

At the output of each receiver, the mean-square-error εₖ=E[|yₖ(ρ)−ŷₖ(ρ)|²] between the transmitted signal yₖ(ρ) and the estimated signal ŷₖ(ρ) is given as

$${γ}_{k} = \frac{1 - {ɛ}_{k}}{{ɛ}_{k}}$$

for k=1, . . . , K. Where

$${ɛ}_{k} = 1 - {E}_{k} {{q}^{->}}_{k}^{H} {C}^{- 1} {{q}^{->}}_{k} = \frac{1}{1 + {γ}_{k}} = 1 - {λ}_{k}$$

is the signal-to-noise-ratio (SNR) at the output of each receiver and λₖ is the system value given as:

$${λ}_{k} = 1 - {ɛ}_{k} = \frac{{γ}_{k}}{1 + {γ}_{k}} = {E}_{k} {{q}^{->}}_{k}^{H} {C}^{- 1} {{q}^{->}}_{k} . \qquad ( 15 )$$

Now that the system value has been defined, the method of determining the weak channels in accordance with the system value to improve the overall system performance shall be discussed in more detail.

The main objective of the MIMO downlink sum capacity optimization is to minimize the total MMSE ε_{T}=Σₖ₌₁^{k*}εₖ using the total MMSE minimization criterion based on the Lagrangian dual objective function:

$$L ( {ɛ}_{k} , {E}_{k} , λ ) = {\sum }_{k = 1}^{{K}^{*}} {ɛ}_{k} + λ ( {\sum }_{k = 1}^{{K}^{*}} {E}_{k} - {E}_{T} ) \qquad ( 16 )$$

with the Lagrangian multiplier λ. The objective function maximizes the total rate B_{T}=Σₖ₌₁^{k*}bₚ_{ₖ} where bₚ_{ₖ} is the number of bits allocated to each spreading sequence symbol for k=1, . . . , K*. Once the energies are allocated, the corresponding rates can be determined. If the terms εₖ and Eₖ are expressed as functions of the rate bₚ_{ₖ} the optimization, given in (16), provides solutions for Eₖ and λ subject to the energy constraint Σₖ₌₁^{k*}Eₖ≦E_{T}. The mean square error energy εₖ is given in terms of the system values λₖ as εₖ=1−λₖ. The energy Eₖ in (16) is related to the system value λₖ by means of

$${E}_{k} = \frac{{λ}_{k}}{{\vec{q}}_{k}^{H} {C}^{- 1} {\vec{q}}_{k}}$$

as identified in (15). The bit rates bₚ_{ₖ} to be transmitted over each channel is related to the SNR

$${γ}_{k} = \frac{{λ}_{k}}{1 - {λ}_{k}}$$

in terms of

$${b}_{{p}_{k}} = {log}_{2} ( 1 + \frac{{γ}_{k}}{Γ} )$$

where Γ is the gap value. The target SNR γ*(bₚ_{ₖ}) is given by:

$${γ}_{k}^{*} ( {b}_{{p}_{k}} ) = Γ ( {2}^{{b}_{{p}_{k}}} - 1 ) , \qquad ( 17 )$$

and the target system value λ*ₖ required to transmit bₚ_{ₖ} bits per symbol is given by:

$${λ}_{k}^{*} ( {b}_{{p}_{k}} ) = \frac{Γ ( {2}^{{b}_{{p}_{k}}} - 1 )}{1 + Γ ( {2}^{{b}_{{p}_{k}}} - 1 )} . \qquad ( 18 )$$

As the optimization parameters are all expressed in terms of the system values, in this embodiment of the invention the system values can be calculated using λₖ=Eₖ\vec{q}ₖ^{H}C⁻¹\vec{q}ₖ given in (15). However, as will be appreciated in other embodiments, where a SIC scheme is utilised, a different system value determination will be used. In accordance with this embodiment of the invention, the mean system value will therefore be:

$${λ}_{mean} = \frac{{λ}_{T}}{{K}^{*}} = \frac{{\sum }_{k = 1}^{{K}^{*}} {λ}_{k}}{{K}^{*}} \qquad ( 19 )$$

where the total system value λ_{T} has its maximum value when

$${E}_{k} = \frac{{E}_{T}}{{K}^{*}}$$

for K=1, . . . , K*. For the MMSE receivers with and without the proposed SIC scheme, the total system capacity is:

$${C}_{T} = {\sum }_{k = 1}^{{K}^{*}} {log}_{2} ( 1 + \frac{{λ}_{k}}{Γ ( 1 - {λ}_{k} )} ) = {K}^{*} {log}_{2} ( 1 + \frac{{λ}_{mean}}{Γ ( 1 - {λ}_{mean} )} ) \qquad ( 20 )$$

where Γ is the gap value. In (20), the multiplication of the total channel number with the capacity corresponding to the mean system value λₘₑₐₙ gives a very close approximation to the total capacity.

In this first embodiment of the invention an iterative bit loading method is produced to allocate discrete rates without the need for a prior energy allocation. This iterative method operates with a given total energy E_{T} when using a MIMO system without the proposed SIC scheme by iterating for a given total number Iₘₐₓ. However, when used with a SIC scheme, a similar approach is applied. The system parameters are considered to be N_{R}, N_{T}, σ², K*, L, H. The signature sequences S=[s₁. . . \vec{s}_{K}] will be available for the purpose of constructing the matrices Q, Q₁, and Q₂. At the start, each iterative method will produce the sequences \vec{q}ₖ, \vec{q}_{k,1} and \vec{q}_{k,2} using \vec{q}ₖ=[Q]ₖ, \vec{q}_{k,1}=[Q₁]ₖ, and \vec{q}_{k,2}=[Q₂]ₖ to generate the initial system values λₖ for k=1, . . . , , K.

The multipath channels cause the system values λₖ to have randomly varying amplitudes. This may lead to the inclusion of some of the spreading sequences as bad channels which may degrade the total rate by excluding the good channels which can otherwise be used to transmit higher data rates. A signature sequence selection scheme based on the use of the system values may be incorporated to identify the weak signature sequences to exclude them.

The iterative method will select a sub set of the sequences from S to identify the optimum number Ks of signature sequences and the order in which they will appear. The method varies the total number of sequences from K=K to K=1. The method initially takes a total of K=K spreading sequences and calculates all the associated system values by allocating the total available energy equally to each spreading sequence. The system values and corresponding spreading sequences are ordered to have the system values in an ascending order. The mean system value and also the signature sequence set are recorded for the corresponding number of spreading sequences. The spreading sequence corresponding to the minimum system value is removed and the number of spreading sequences is reduced using K=K−1 and the corresponding system values, the mean system value calculations and signature sequence ordering and removal processes are repeated for the reduced number of spreading sequences by varying the number of spreading sequences from K=K to K=1. For varying number of spreading sequences, from K=1 to K=K, the mean system values are used to calculate the data rate bₚ to be transmitted over each spreading sequence if all the spreading sequences use the same transmission rate. The number of spreading sequences which maximizes the multiplication of the data rate bₚ and the corresponding number of spreading sequence is chosen to be the optimum number K* of spreading sequences. The recorded signature sequence set corresponding to the optimum number of signature sequences is chosen to be the ordered set of signature sequences. The data rate bₚ corresponding to the optimum number of spreading sequences and the next data rate bₚ₊₁ that is available in the discrete data rates set of {bₚ: p=1, . . . P} and the corresponding target system values will be used to determine the number of channels K*−m in that will be used to transmit data at the rate bₚ bits per symbol and the number of channels m that will used to transmit data at the rate bₚ₊₁ by considering the mean system value corresponding to the optimum number of signature sequences. After having determined the data rates bₚ and bₚ₊₁ and the number of spreading sequences K*−m and m the energies required to transmit the data at the required rates bₚ and bₚ₊₁ are calculated iteratively for a given total energy constraint Σₖ₌₁^{K*}Eₖ≦E_{T}.

The details of determining the optimum number of sequences and the order they appear and also the data rate and energy allocations are given next.

The method will dynamically adjust the energies Eₖ for k=1, . . . , K* and also K* by starting at K* =K to return the allocated energies and the numbers of the ordered signature sequences as the elements of the size IC vector k* vector \vec{k}_{order}. The vector \vec{k}_{order} will be initialized using [\vec{k}_{order}]ₖ=k for k=1, . . . , K*. At the start a set of system values λₖ, given in (15), for k=1, . . . , K* will be produced as the elements of the size K* vector \vec{λ}=└λ₁, . . . λ_{K*}┘ using

$${E}_{k} = \frac{{E}_{T}}{{K}^{*}}$$

and C⁻¹, given in (13). The vector \vec{λ} will then be used to reorganize the match filter sequences using \vec{q}ₖ=qₐ_{ₖ}, \vec{q}_{k,1}=\vec{q}ₐ_{ₖ}_{,1} and \vec{q}_{k,2}=\vec{q}ₐ_{ₖ}_{,2} and the vector \vec{k}_{order} using [\vec{k}_{order}]ₖ=[\vec{k}_{order}]ₐ_{ₖ} for k=1, . . . , K* where aₖ is the index number of the k^{th} smallest element of \vec{λ}.

At the start of each iteration, a set of system values λₖ for k=1, . . . , K*, given in (15) will be constructed by using the variables N, L, N_{R}, σ² and an updated set of energies Eₖ and the vectors \vec{q}ₖ, \vec{q}_{k,1}, \vec{q}_{k,2} and \vec{k}_{order} and also using C⁻¹, given in (13). Within each iteration loop the system values, given in \vec{λ}=└λ₁, . . . λ_{K*}┘ will be reordered in an ascending order. As required the optimum number K* and the corresponding energies will be updated. The index number of the K* smallest element of \vec{λ} will be used to re-order the sequences \vec{q}ₖ, \vec{q}_{k,1} and \vec{q}_{k,2}, the allocated energies Eₖ and the elements of the vector \vec{k}_{order}. The iterative algorithms will reduce the number of sequences \vec{q}ₖ, \vec{q}_{k,1}, \vec{q}_{k,2} and the energies and also the size of vector k_{order} when required as the iterations progress. Upon reaching a given number of iterations, the iterative loop will terminate otherwise the iteration will be repeated by starting at the beginning.

Upon completing the iterations, the data rates bₚ_{ₖ}, the energies and also a set of re-sequenced signature sequences \vec{s}ₖ for k=1, . . . , K* are returned. The resultant energies Eₖ and the matrix C⁻¹ involved in the construction of the system values λₖ will be available to calculate the MMSE filter coefficients \vec{w}ₖ for k=1, . . . , K* using (12). The total system value, λ_{T}, and the mean system value, λₘₑₐₙ, and also the sum capacity for each iterative method can be calculated using (19) and (20) respectively.

This approach for maximizing the total capacity by allocating discrete rates first and finding the optimum number of sequences without the need to allocate energies prior to rates shall now be discussed in more detail.

With the target system values identified in (18) in terms of the available discrete rates, a margin adaptive (MA) loading algorithm will be considered initially for either an equal SNR loading to transmit the same data rate over each channel such that the total transmission rate is R_{T}=Kbₚ_{ₖ}. The equal SNR loading scheme operates under the same energy constraint that Σₖ₌₁^{K*}Eₖ≦E_{T}. The equal energy loading is the adapted strategy for the current HSDPA standards and it produces varying SNRs at the receivers which makes it simpler to implement than the equal SNR loading scheme. The equal SNR loading requires adjustment of the transmission energies to achieve a fixed SNR at each receiver to deliver a higher total bit rate.

The numbers of sequences K*_{SNR} for the equal SNR case will be optimized to maximize the total rate R_{T,SNR}. The algorithm will initially set the temporary optimum number Kₒₚₜ=K and will use the vectors \vec{q}ₖ, \vec{q}_{k,1} and \vec{q}_{k,2} for k=1, . . . , Kₒₚₜ and \vec{k}_{order} and also the parameters E_{T}, N_{T}, N_{R}, σ², K, L. A size K vector with the initial values \vec{b}ₘₑₐₙ=\vec{0}_{K} and an N_{T}K×K dimensional matrix K_{squences} with the initial values K_{squences}=0_{K×K} will be generated as part of the following iterative process.

1.

$${[ {K}_{sequences} ]}_{k , {K}_{opt}} = {[ {\vec{k}}_{order} ]}_{k}$$

for k=1, . . . Kₒₚₜ. By setting

$${E}_{k} = \frac{{E}_{T}}{{K}_{opt}}$$

the system values λₖ are produced for k=1, . . . , Kₒₚₜ using (15) for the system under consideration without SIC. The Kₒₚₜ^{th} elements of two size K vectors are produced by setting

$${[ {\vec{λ}}_{mean} ]}_{{k}_{opt}^{/}} = \frac{{\sum }_{k}^{{K}_{opt}} {λ}_{k}}{{K}_{opt}} {and [ {\vec{λ}}_{min} ]}_{{k}_{opt}}$$

equal to the minimum of the system values. The size Kₒₚₜ system value vector \vec{λ} is constructed using \vec{λ}=└λ₁. . . , λ_{K}_{ₒₚₜ}┘^{T}.

2. Next the term aₖ is used as the index number of the k^{th} smallest element of the system value vector \vec{λ}. The index number aₖ is employed to re-sequence the vectors \vec{q}ₖ, \vec{q}_{k,1} and \vec{q}_{k,2} and to reorder the elements of the vector \vec{k}_{order} using \vec{q}ₖ=\vec{q}ₐ_{ₖ}, \vec{q}_{k,1}=\vec{q}ₐ_{ₖ}_{,1} and \vec{q}_{k,2}=\vec{q}ₐ_{ₖ}_{,2} and [\vec{k}_{order}]ₖ=[\vec{k}_{order}]ₐ_{ₖ} for k=1, . . . , Kₒₚₜ. The total number, Kₒₚₜ, of sequences \vec{q}ₖ, \vec{q}_{k,1}, \vec{q}_{k,2} and the size, Kₒₚₜ, of the vector \vec{k}_{order} are reduced from Kₒₚₜ+1 to Kₒₚₜ using \vec{q}ₖ\vec{q}ₖ₊₁, \vec{q}_{k,1}=\vec{q}_{(k+1),1} and \vec{q}_{k,2}=\vec{q}_{(k+1),2} and also [\vec{k}_{order}]ₖ=[\vec{k}_{order}]ₖ₊₁ for k=1, . . . , Kₒₚₜ.

3. By setting K=Kₒₚₜ−1 the steps are repeated starting at step 1 if Kₒₚₜ≧1 otherwise the following steps are run.

4. The k^{th} element of the vector \vec{b}ₘₑₐₙ is set to be [\vec{b}ₘₑₐₙ]ₖ=bₚ_{ₖ} for k=1, . . . , K where the discrete bit value bₚ_{ₖ} is chosen to satisfy the inequalities:

$${λ}^{*} ( {b}_{{p}_{k}} ) \leq {[ {\vec{λ}}_{mean} ]}_{k} < {λ}^{*} ( {b}_{{p}_{k} + 1} ) . \qquad ( 21 )$$

The optimum number K*_{SNR} of the transmission sequences for the equal SNR loading system is given by

$${K}_{SNR}^{*} = arg ( {max}_{1 \leq k \leq K} ( {k [ {\vec{b}}_{mean} ]}_{k} ) )$$

where K_{SNR} is the integer number maximizing k└\vec{b}ₘₑₐₙ┘ₖ for k=1, . . . , K. The total rate is R_{T,SNR}=K*_{SNR}bₚ_{ₖ} where bₚ_{ₖ}=[\vec{b}ₘₑₐₙ]_{K*}_{_{SNR}}. The total rate can be further improved by loading a certain number of channels in with the next available rate bₚ_{ₖ}₊₁ and transmitting a total number of bits per symbol using:

R_{T,SNR}=(K*_{SNR}−m)bₚ_{ₖ}+mbₚ_{ₖ}₊₁ (22)

for the integer m which satisfies the following inequalities:

(K*_{SNR}−m)λ*(bₚ_{ₖ})+mλ*(bₚ_{ₖ}₊₁)≦K*_{SNR}[\vec{λ}ₘₑₐₙ]_{K*}_{_{SNR}}. (23)

Thus R_{T}=(K*_{SNR}−m)bₚ_{ₖ}+mbₚ_{ₖ}₊₁ can be determined prior to the energy allocation.

5. The signature sequences

$${S}^{( SNR )} = [ {\vec{s}}_{1}^{( SNR )} , … , {\vec{s}}_{{K}_{SNR}^{*}}^{( SNR )} ]$$

for the equal SNR loading scheme are constructed using the original sequence matrix S=[\vec{s}₁ . . . \vec{s}_{K}] and setting \vec{s}ₖ^{(SNR)}=\vec{s}ₐ_{ₖ} where aₖ=└K_{squences}┘_{k,K*}_{_{SNR}} for k=1, . . . , K*_{SNR}.

An iterative energy adjustment method is presented below as the proposed method maximizing the total rate R_{T,SNR}=(K*_{SNR}−m)bₚ_{ₖ}+mbₚ_{ₖ}₊₁ relies on maintaining two specific SNRs at the output of despreading units.

For the optimum number of codes K* and the allocated bit rates

$${b}_{{p}_{k}} or {b}_{{p}_{k} + 1}$$

for each channel, the transmission energies Eₖ for k=1, . . . , K*, can be iteratively calculated for a MIMO system without the SIC scheme. It is assumed that the matched filter sequences \vec{q}ₖ, \vec{q}_{k,1} and \vec{q}_{k,2} for k=1, . . . , K* are available for the ordered sequences. For the systems without the SIC scheme, the transmission energies can be calculated iteratively as follows:

$${E}_{k , i} = \frac{{λ}_{k}^{*}}{{\vec{q}}_{k}^{H} {C}_{i - 1}^{- 1} {\vec{q}}_{k}} for k = 1 , … , {K}^{*} \qquad ( 24 )$$

by using (15) and the target system values λ*ₖ given in (18) for the chosen rates bₚ_{ₖ} and

$${b}_{{p}_{k} + 1} .$$

The term i is the iteration nubmer and the term Cᵢ₋₁⁻¹ in (24) is calculated using (13) and E_{k,(i-1)} for k=1, . . . , K by initially allocating

$${E}_{k , 0} = \frac{{E}_{T}}{{K}^{*}}$$

for all channels. This iteration continues until the energies converge to fixed values or a maximum number of iterations, Iₘₐₓ, is reached.

A second embodiment of the invention shall now be described in which a SIC-based receiver is utilised. The features of the first and second embodiemtns of the invention are very similar and as such those features of the second embodiment of the invention to that are the same as the first embodiment of the invention shall not be described in detail.

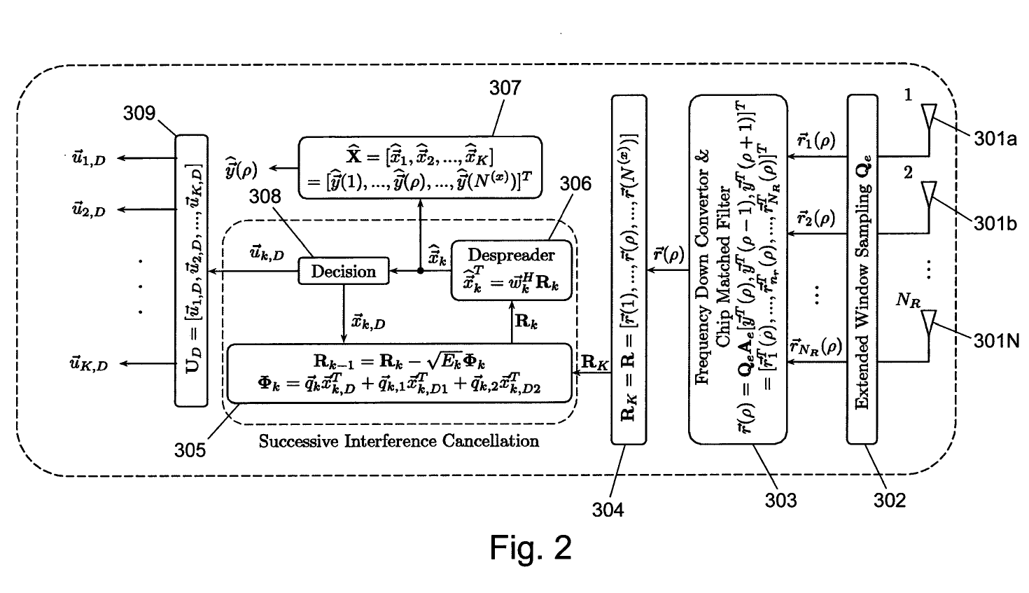

FIG. 2 illustrates the system of the second embodiment of the invention in which a SIC-based receiver is utilised. Like in FIG. 1, the receiver 300 comprises a plurality of MIMO receivers 301a, 301b, . . . 301N_{R}. The receiver chip matched filter 302 down converts the received radio frequency signals and filters the down converted signals to produce the sampled signal vectors

$${\vec{r}}_{{n}_{r}} ( ρ ) = {[ \begin{matrix}{r}_{{n}_{r} , 1} & … & {r}_{{n}_{r} , ( N + L - 1 )}\end{matrix} ( ρ ) ]}^{T}$$

to be processed for the symbol period of ρ at the output of each receiver antenna. The received vector concatenator unit 303 concatenates signal vectors

$${\vec{r}}_{{n}_{r}} ( ρ ) = {[ \begin{matrix}{r}_{{n}_{r} , 1} & … & {r}_{{n}_{r} , ( N + L - 1 )}\end{matrix} ( ρ ) ]}^{T}$$

to produce the received matched filtered signal samples corresponding to all antenna elements at a symbol period \vec{r}(ρ)=[\vec{r}₁^{T}(ρ), . . . , \vec{r}ₙ_{ᵣ}^{T}(ρ), . . . , \vec{r}_{N}_{_{R}}^{T}(ρ)]^{T} for ρ=1, . . . , N^{(x)}−1. The received signal matrix generator 304 produces the received signal matrix R_{K*}=[\vec{r}(1), . . . , \vec{r}(N^{(x)})]. The successive interference cancellation (SIC) receiver consisting of units 305, 306 and 308 is an iterative receiver producing the reduced data matrix Rₖ₋₁ iteratively for k=1 . . . , K* using Rₖ₋₁=Rₖ−\sqrt{Eₖ}Φₖ starting with the matrix R_{K*}, the combined SIC receiver consisting of units 305, 306 and 308 uses the despreading unit 306 to produce the despread signal vector of

$${{x}^{\hat{\to }}}_{k}^{T} = {\vec{w}}_{k}^{H} {R}_{k}$$

for k=K*,(K*−1), . . . 1. The decision unit 308 uses the despread signal to produce an estimate of the corresponding transmitted bit stream \vec{û}ₖ and also the transmitted symbol vector \vec{x}_{k,D}. The detected data stream \vec{x}_{k,D} at the output of the decision unit 308 is used by the contribution estimator unit 305 to produce the contributions matrix Φₖ for use in the reduced data matrix Rₖ₋₁ calculation when using Rₖ₋₁=Rₖ−\sqrt{Eₖ}Φ. The detected data stream is then ordered by the data ordering unit 309 to produce the detected data sequence. The symbol matrix generation unit 307 uses the estimated symbols vectors {right arrow over (\hat{x}ₖ to produce the received symbols matrix \vec{X}.

When a SIC-based receiver is utilised the definition and determination of the system value λₖ also change. The determination of the system value λₖ in accordance with a system utilising a SIC-based receiver is therefore set out below.

Use of a successive interference cancellation (SIC) scheme has many benefits including improved received signal-to-noise ratio for a given total transmission energy E_{T} requiring less energy Eₖ per channel for k=1, . . . , K* to achieve a given bit rate.

An SIC scheme, which operates as shown in FIG. 2, constructs a unique covariance matrix Cₖ for k=1, . . . , K* using the iterative covariance matrix relationship given in (14) and calculates Cₖ⁻¹ for use in the detection process.

The operation of the SIC receiver depends on the design of the MMSE linear equalizer coefficients \vec{w}ₖ which are produced by re-formulating (12) as follows for k=1, . . . , K*:

$${\vec{w}}_{k} = \frac{{C}_{k}^{- 1} {\vec{q}}_{k}}{{\vec{q}}_{k}^{H} {C}_{k}^{- 1} {\vec{q}}_{k}} . \qquad ( 25 )$$

In the SIC receiver implementation, the received signal vectors \vec{r}(ρ), given in (11), are collected for ρ=1, . . . , N^{(x)} to form the received signal matrix R=[\vec{r}(1), . . . ,\vec{r}(N^{(x)})] and the receiver is operated by setting R_{K*}=R to produce a N_{R}(N+L−1)×N^{(x)} dimensional reduced data matrix Rₖ₋₁ iteratively using Rₖ₋₁Rₖ−\sqrt{Eₖ}Φₖ for k=K*,(K*−1), . . . , 1. The N_{R}(N+L−1)×N^{(x)} dimensional matrix Φₖ is given by Φₖ=\vec{q}ₖ\vec{x}_{k,D}^{T}+\vec{q}_{k,1}\vec{x}_{k,D1}^{T}+\vec{q}_{k,2}\vec{x}_{k,D1}^{T}. The size N^{(x)} column vector \vec{x}_{k,D} is the detected data stream and \vec{x}_{k,D1}=J_{N}_{^{(x)}}\vec{x}_{k,D} and \vec{x}_{k,D1}=J_{N}_{^{(x)}}^{T}\vec{x}_{k,D} are the row vectors containing ISI symbols received in the previous and the next symbol periods respectively. The contribution of the detected data stream \vec{x}_{k,D} to the reduced to signal matrix Rₖ for channel k is estimated using \sqrt{Eₖ}Φₖ. The estimated symbol vector \vec{x}_{k,D} is generated by using each MMSE despreading vector \vec{w}ₖ which is calculated using (25) to yield a despread signal vector of

$${\hat{\vec{x}}}_{k}^{T} = {\vec{w}}_{k}^{H} {R}_{k}$$

and also an estimate of the corresponding transmitted bit stream {right arrow over (\hat{û}ₖ. The decoded bit vectors \vec{u}ₖ are re-coded at the receiver and re-modulated to regenerate the transmitted symbol vector \vec{x}_{k,D} at the output of the decision device. For each channel k, the receiver then re-spreads the estimated data symbols \vec{x}_{k,D} and the re-spread data stream is then passed through the channel under consideration to produce Φₖ. Once Rₖ₋₁ is generated, the received symbol vector for each channel is then iteratively generated using

$${{x}^{\hat{\to }}}_{k - 1}^{T} = {\vec{w}}_{k - 1}^{H} {R}_{k - 1}$$

until all the transmitted data streams are estimated for k=K*, . . . , 1. The SIC based MMSE receiver will then have the following modified system values for k=1 , . ., K* as:

λₖ=Eₖ\vec{q}ₖ^{H}Cₖ⁻¹\vec{q}ₖ (26)

and the best performance can be achieved for the SIC based receivers if the system values are ordered in an ascending order.

Use of an iterative covariance matrix inversion method with the SIC receiver further reduces the receiver detection complexity. The iterative matrix inversion method is also used to produce the SIC system values λₖ, k=1, . . . , K* for use in the maximization of the summation of the discrete transmission rate b_{T}Σₖ₌₁^{K*}bₚ_{ₖ} where bₚ_{ₖ} is the discrete number of bits allocated to each spreading sequence symbol for k=1, . . . , K*. The SIC system values λₖ will also be used for the optimum allocation of energies subject to the energy constraint Σₖ₌₁^{K*}Eₖ≦E_{T}.

The main complexity issue for a successive interference cancellation receiver is the number of matrix inversions Cₖ⁻¹ involved in calculating the despreader \vec{w}ₖ given in (25) and the system value λₖ given in (26) for k=1, . . . , K*. This motivates the formulation of an iterative covariance matrix inversion. The objective is to eliminate the covariance matrix inversions required for the despreader and the system value calculations such that the inverse matrix Cₖ⁻¹ is a function of Cₖ₋₁⁻¹. By reorganizing (14) as Cₖ=DₖEₖ\vec{q}ₖ\vec{q}ₖ^{H} where Dₖ=Cₖ₋₁+Eₖ\vec{q}_{k,1}\vec{q}_{k,1}^{H}+Eₖ\vec{q}_{k,2}\vec{q}_{k,2}^{H} and using the matrix inversion lemma (A+UBV)⁻¹A⁻¹−A⁻¹U(B⁻¹+VA⁻¹U)VA⁻¹ the inverse matrices Cₖ⁻¹ and Dₖ⁻¹ can be calculated as:

Dₖ⁻¹=Cₖ₋₁⁻¹−(ζ₁²ζ₂|ξ₅|²+ζ₁)Z₁

−ζ₂Z₂+ζ₁ζ₂(ξ₅Z₃+ξ*₅Z₃^{H}) and (27)

Cₖ⁻¹=Dₖ⁻¹ζZ₄ (28)

where we define the distance vectors \vec{d}, \vec{d}₁, \vec{d}₂, and \vec{d}₃ as:

\vec{d}=Cₖ₋₁⁻¹\vec{q}ₖ, \vec{d}₁=Cₖ₋₁⁻¹\vec{q}_{k,1}, \vec{d}₂=Cₖ₋₁⁻¹\vec{q}_{k,2}, \vec{d}₃=Dₖ⁻¹\vec{q}ₖ. (29)

The weighting functions ξ, ξ₁, ξ₂, ξ₃, ξ₄, ξ₅, and ξ₆ are produced using:

ξ=\vec{q}ₖ^{H}\vec{d}, ξ₁=\vec{q}_{k,1}^{H}\vec{d}₁, ξ₂=\vec{q}_{k,2}^{H}\vec{d}₂,

ξ₃=\vec{q}ₖ^{H}\vec{d}₁, ξ₄=\vec{q}ₖ^{H}\vec{d}₂, ξ₅=\vec{q}_{k,1}^{H}\vec{d}₂, ξ₆=Real(ξ₃ξ*₄ξ₅) (30)

The weighted energy terms ζ, ζ₁ and ζ₂ are given as:

$$ζ = \frac{{E}_{k}}{1 + {E}_{k} ( \begin{matrix}ξ - \frac{{E}_{k} {\vert {ξ}_{3} \vert}^{2}}{1 + {E}_{k} {ξ}_{l}} - \\ \frac{{E}_{k} ( {\vert {ξ}_{4} \vert}^{2} - 2 \frac{{E}_{k}}{1 + {E}_{k} {ξ}_{1}} {ξ}_{6} + {( \frac{{E}_{k}}{1 + {E}_{k} {ξ}_{1}} )}^{2} {\vert {ξ}_{5} \vert}^{2} {\vert {ξ}_{3} \vert}^{2} )}{1 + {E}_{k} ( {ξ}_{2} - \frac{{E}_{k}}{1 + {E}_{k} {ξ}_{1}} {\vert {ξ}_{5} \vert}^{2} )}\end{matrix} )} , \\ {ζ}_{1} = \frac{{E}_{k}}{1 + {E}_{k} {ξ}_{1}} , {ζ}_{2} = \frac{{E}_{k}}{1 + {E}_{k} ( {ξ}_{2} - {ζ}_{1} {\vert {ξ}_{5} \vert}^{2} )} . \qquad ( 31 )$$

We further define the interim matrices Z₁, Z₂, Z₃ and Z₄ as follows:

Z₁=\vec{d}₁\vec{d}₁^{H}, Z₂=\vec{d}₂\vec{d}₂^{H}, Z₃=\vec{d}₁\vec{d}₂^{H}, Z₄=\vec{d}₃\vec{d}₃^{H}. (32)

For a given energy allocation Eₖ for k=1, . . . , K* and a given set of M1MO system parameters with \vec{q}ₖ, \vec{q}_{k,1} and \vec{q}_{k,2}, Eₖ, σ² and also

$${C}_{0}^{- 1} = \frac{1}{2 {σ}^{2}} {I}_{{N}_{R} ( N + L - 1 )} ,$$

the matrix Cₖ⁻¹ and the system values λₖ are constructed as follows starting at k=1.

1. The distance vectors, \vec{d}, \vec{d}₁ and \vec{d}₂ are produced using (29). The weighting factors ξ, ξ₁, ξ₂, ξ₃, ξ₄, ξ₅, and ξ₆, given in (30), are calculated to produce the weighted energy terms ζ, ζ₁, and ζ₂ using (31) and the allocated energy Eₖ for k=1, . . . , K*. The interim matrices Z₁, Z₂ and Z₃, given in (32), are calculated to construct Dₖ⁻¹ employing (27).

2. The distance vector \vec{d}₃ and the corresponding matrix Z₄ , given by (29) and (32), are used to construct Cₖ⁻¹ given in (28).

3. The system value is obtained using λₖ=Eₖ\vec{q}ₖ^{H}Cₖ₋₁⁻¹\vec{q}ₖ.

4. Stop the algorithm if k=K* . Otherwise by setting k=k +1, the steps are repeated starting at step 1.

The system value λₖgiven in (26) is reorganized using (28) to simplify the signal to noise ratio γₖ at the output of the k^{th} SIC receiver to the following form:

$${γ}_{k} = \frac{{λ}_{k}}{1 - {λ}_{k}} = {E}_{k} {\vec{q}}_{k}^{H} {D}_{k}^{- 1} {\vec{q}}_{k} \qquad ( 33 )$$

using the relationships given in (29), (30), (31) and (32). The proposed SIC-based iterative method calculates Cₖ⁻¹ starting with the first channel k=1 using (27) and (28) and Cₖ₋₁⁻¹ which is constructed in the previous iteration starting at

$${C}_{0}^{- 1} = \frac{1}{2 {σ}^{2}} {I}_{{N}_{R} ( N + L - 1 )} .$$

This iterative covariance matrix inversion method will be used to produce the signal-to-noise ratio γₖ and the system values λₖ for k=1, . . . , K* which will be ordered in an ascending order to maximize the SIC based HSDPA downlink sum-capacity performance.

The energy of the k^{th} channel, E_{k,i}, which is updated using (24) and Cᵢ₋₁⁻¹ which needs to be updated using energies of all K channels at (i−1)^{th} iteration. This motivates the formulation of an iterative energy allocation E_{k,i} that only depends on E_{k,1-1} such that the covariance matrix inverse Cₖ⁻¹ only needs to be updated once per channel using Eₖ .

A method for calculating the energies iteratively Eₖ, without the need to invert any matrix per energy iteration, according to an alternative embodiment of the invention is set-out below.

By reorganizing (33) as follows:

$${E}_{k , i} = \frac{{γ}_{k}^{*}}{{\vec{q}}_{k}^{H} {D}_{k , ( i - 1 )}^{- 1} {\vec{q}}_{k}} \qquad ( 36 )$$

to produce E_{k,i} in terms of E_{k,1-1} and the parameters constructed from Cₖ₋₁⁻¹ and \vec{q}ₖ, \vec{q}_{k,1}, and \vec{q}_{k,2}. For this purpose the term \vec{q}ₖqₖDₖ⁻¹\vec{q}ₖ given in (34) is simplified using (27) to reformulate (34) as follows:

$${E}_{k , i} = \frac{{γ}_{k}^{*}}{\begin{matrix}ξ - \frac{{E}_{k , ( i - 1 )} {\vert {ξ}_{3} \vert}^{2}}{1 + {E}_{k , ( i - 1 )} {ξ}_{1}} - \\ \frac{{E}_{k , ( i - 1 )} ( {\vert {ξ}_{4} \vert}^{2} - 2 \frac{{E}_{k , ( i - 1 )}}{1 + {E}_{k , ( i - 1 )} {ξ}_{1}} {ξ}_{6} + {( \frac{{E}_{k , ( i - 1 )}}{1 + {E}_{k , ( i - 1 )} {ξ}_{1}} )}^{2} {\vert {ξ}_{5} \vert}^{2} {\vert {ξ}_{3} \vert}^{2} )}{1 + {E}_{k} ( {ξ}_{2} - \frac{{E}_{k , ( i - 1 )}}{1 + {E}_{k , ( i - 1 )} {ξ}_{1}} {\vert {ξ}_{5} \vert}^{2} )}\end{matrix}} \qquad ( 35 )$$

where the weighting factors ξ, ξ₁, ξ₂, ξ₃, ξ₄, ξ₅, and ξ₆ are constructed from Cₖ₋₁⁻¹ and \vec{q}ₖ, \vec{q}_{k,1} and \vec{q}_{k,2} using (30) and the distance vectors, \vec{d}, \vec{d}₁ and \vec{d}₂ given in (29) and by setting

$${C}_{0}^{- 1} = \frac{1}{2 {σ}^{2}} {I}_{{N}_{R} ( N + L - 1 )}$$

and the starting channel number to be k=1. This iterative energy calculation requires the use of the target SNR values

$${γ}^{*} ( {b}_{{p}_{k}} ) and {γ}^{*} ( {b}_{{p}_{k} + 1} )$$

from (17) for the desired transmission rates bₚ_{ₖ} and bₚ_{ₖ}₊₁. The initial value for the energy Eₖ is set to be

$${E}_{k} = \frac{{E}_{T}}{{K}^{*}}$$

and then it is iteratively updated using (35) for the target SNR γ*ₖ corresponding to the chosen transmission rate bₚ_{ₖ} for channel k. The iterations continue until the energy converges to a fixed value or a given number of iteration number Iₘₐₓ is reached. Once the energy Eₖ is produced, the construction of in terms of Cₖ⁻¹ and E_{k,i} requires the interim matrices Z₁, Z₂ and Z₃ which are calculated using (32) to construct Dₖ⁻¹ using (27) and then to produce \vec{d}₃=Dₖ⁻¹\vec{q}ₖ using (29) and also Z₄ using (32). The weighted energy term ζ is next calculated using

$$ζ = \frac{{E}_{k}}{1 + {γ}_{k}^{*}} .$$

Using the resultant Dₖ⁻¹, Z₄ and ζ the inverse matrix Cₖ⁻¹ is constructed using (28). This process is repeated for each channel until all the energies and inverses of the covariance matrices are produced for all the channels for k=1, . . . , K*. Once the energies are allocated the transmitter provides the receiver with the allocated energies.

In accordance with a third embodiment of the invention the selection of the spreading sequences may be achieved by means of a minimum system value based discrete bit loading algorithm. The minimum system value based approach replaces the mean system value based approach discussed in respect of the first and second embodiments of the invention. As such, the third embodiment of the invention is applicable for either the non-SIC based receiver of the first embodiment of the invention, or the SIC-based receiver of the second embodiment of the invention. Only those features of the third embodiment of the invention that differ to either of the first or second embodiments of the invention shall be discussed in detail.

The numbers of sequences K*_{EE}, for the equal energy cases will be optimized to maximize the total rate R_{T,EE}. The algorithm will initially set the temporary optimum number Kₒₚₜ=K and will use the vectors \vec{q}ₖ, \vec{q}_{k,1} and \vec{q}_{k,2} for k=1, . . . , Kₒₚₜ and \vec{k}_{order} and also the parameters E_{T}, N_{T}, N_{R}, σ², K, L. A size K vector with the initial values \vec{b}ₘᵢₙ=\vec{0}_{K} an N_{T}K×K dimensional matrix K_{squences} with the initial values K_{squences}=0_{K×K} will be generated as part of the following iterative process after having run the first three steps outlined as part of the first embodiment of the invention.

1. The k^{th} element of the minimum bit rates vector \vec{b}ₘᵢₙ is set to [\vec{b}ₘᵢₙ]ₖ=bₚ_{ₖ} for k=1, . . . , K by choosing the discrete bit value bₚ_{ₖ} to satisfy the inequalities:

λ*(bₚ_{ₖ})≦[\vec{λ}ₘᵢₙ]ₖ<λ*(bₚ_{ₖ}₊₁) (36)

2. The optimum number K*_{EE} is given by

$${K}_{EE}^{*} = arg ( {max}_{1 \leq k ≦ K} ( {k [ {\vec{b}}_{min} ]}_{k} ) )$$

and the total rate is R_{T,EE}=K*_{EE}b₁^{(min)} where b₁^{(min)}=[\vec{b}ₘᵢₙ]_{K*}_{_{EE}} for the equal energy loading scheme. The total number of bits can be further increased by identifying a total of m channels which maximizes

$$m = arg ( {max}_{1 \leq k < ( K - {K}_{EE}^{*} - 1 )} ( {k [ {\vec{b}}_{min} ]}_{k} ) )$$

with the rate b₂^{(min)}=[\vec{b}ₘᵢₙ]ₘ to transmit a total number of bits:

R_{T,EE}=(K*_{EE}−m)b₁^{(min)}+mb₂^{(min)}. (37)

2. The signature sequences

$${S}^{( EE )} = [ {\vec{s}}_{1}^{( EE )} , … , {\vec{s}}_{{K}_{EE}^{*}}^{( EE )} ]$$

for the equal energy loading scheme is constructed using the original sequence matrix S=[\vec{s}₁. . . \vec{s}_{K}] and setting \vec{s}ₖ^{(EE)}\vec{s}_{c}_{ₖ} where cₖ=└K_{squences}┘_{k,K*}_{_{EE}} for k=1, . . . , K*_{EE*}.

For the equal energy loading scheme, the energy is set to

$${E}_{k} = \frac{{E}_{T}}{{K}_{EE}^{*}}$$

for each channel k=1, . . . , K*_{EE}.

According to a fourth embodiment of the invention an iterative water-filling based continuous bit loading method is utilised in place of the mean system value bit loading method of the first embodiment of the present invention. Again, the fourth embodiment of the invention can be utilised with either the non-SIC based receiver of the first embodiment of the invention, or the SIC-based receiver of the second embodiment of the invention. Furthermore, only those features of the fourth embodiment of the invention that differ to the previously described embodiments of the invention shall be discussed in detail.

The method will initially set the optimum number K* of channels to be K*=K. At the start, a set of system values λₖ, given in (15), for k=1, . . . , K* will be produced as the elements of the size K* vector \vec{λ}=└λ₁, . . . λ_{K*}┘ using

$${E}_{k} = \frac{{E}_{T}}{{K}^{*}}$$

and C⁻¹, given in (13). The vector \vec{λ} will then be used to reorganize the match filter sequences using \vec{q}ₖ=\vec{q}ₐ_{ₖ}, \vec{q}_{k,1}=\vec{q}ₐ_{ₖ}_{,1} and \vec{q}_{k,2}=\vec{q}ₐ_{ₖ}_{,2} and the vector \vec{k}_{order} using [\vec{k}_{order}]ₖ=[\vec{k}_{order} ]ₐ_{ₖ} for k=1, . . . , K* where aₖ is the index number of the k^{th} smallest element of \vec{λ}. Next the iterations will start. During each iteration the system values will be calculated either using (26) or (15) and the system values and corresponding signature sequences will be ordered such that the system values will appear in an ascending order. The system values will then be used to calculate the channel SNR values and the water filling constant. The channel SNRs and the water filling constant will be used to allocate energies to each channel. If the energy for the first spreading sequence is negative the first spreading sequence will be removed and the above steps will be repeated until the first energy allocation is positive. For a positive first energy allocation the system value calculations, reordering of signature sequences and system values, the channel SNR and water filling calculations and also the energy allocation calculations will be repeated for a given number of iterations. With the final energy allocations the corresponding system values will be used to calculate the signal to noise ratio for each spreading sequence. The SNR values will be used to determine the rate allocated to each spreading sequence.

The water filling algorithm is iterated as follows:

1. The loop counter, I, is set to to be I=1. If K*<K the number of energies Eₖ and the sequences \vec{q}ₖ, \vec{q}_{k,1}, \vec{q}_{k,2} and hence the size, K*, of vector \vec{k}_{order} are reduced from K*+1 to K* using Eₖ=Eₖ₊₁ and \vec{q}ₖ=\vec{q}ₖ₊₁, \vec{q}_{k,1}=\vec{q}_{(k+1),1} and \vec{q}_{k,2}=\vec{q}_{(k+1),2} and also [\vec{k}_{order}]ₖ=[\vec{k}_{order}]ₖ₊₁ for k=1, . . . , K*.

2. For the system under consideration a set of system values λₖ are produced using either (26) or (15) to construct the size K* channel SNR vector \vec{g} using

$${[ \vec{g} ]}_{k} = \frac{{λ}_{k}}{{E}_{k} ( 1 - {λ}_{k} )} ,$$

for k=1, . . . , K*. The water filling constant is calculated as

$${K}_{WF} = \frac{1}{{K}^{*}} ( {E}_{T} + Γ {\sum }_{k = 1}^{{K}^{*}} \frac{1}{{[ \vec{g} ]}_{k}} ) .$$

The energies are allocated using

$${E}_{k} = {K}_{WF} - \frac{1}{{[ \vec{g} ]}_{k}} for k = 1 , … , {K}^{*} .$$

3. Next the term aₖ is used as the index number of the k^{th} smallest element of \vec{g}. The index number aₖ is employed to re-sequence the vectors, the energies and also the elements of the vector \vec{k}_{order} using \vec{q}ₖ=\vec{q}ₐ_{ₖ}, \vec{q}_{k,1}=\vec{q}ₐ_{ₖ}_{,1} and \vec{q}_{k,2}=\vec{q}ₐ_{ₖ}_{,2} and Eₖ=Eₐ_{ₖ} and also [\vec{k}_{order}]ₖ=[\vec{k}_{order}]ₐ_{ₖ} for k=1, . . . , K*.

4. If E₁<0, the number of channels to be used is set to be K*=K*=1 and the steps are repeated starting with step 1. Otherwise the counter is increased using I=I+1 and then if I<Iₘₐₓ the steps are repeated starting at step 2.

The iterative water filling algorithm returns the non-discrete rates and also the reordered signature sequences using \vec{s}^{(WF)}=\vec{s}ₐ_{ₖ} where aₖ=[\vec{k}_{order}]ₖ for k=1, . . . , K*. The iterative water filling sum capacity upper bound can be obtained using the system values identified during the last iteration I=Iₘₐₓ.

After having run the water filling algorithm to determine the optimum number of sequences and also the order of sequences, this algorithm is then re-run by reducing the total number of available codes from K to 1 in steps of 1. The total number of codes which results in the highest total rate is then chosen to be the optimum number of codes.

While the above-mentioned embodiments of the invention all relate to MEMO-based systems it will be appreciated that in accordance with alternative embodiments of the invention, SISO-based systems are utilised. In SISO-based systems it will be appreciated that Nᵣ=1 and N_{R}=1.

It will be appreciated that the terms spreading sequence and channel can be interchangeable.

The various methods described above may be implemented in hardware or by a computer program. When implemented by a computer program a computer could be provided having a memory to store the computer program, and a processor to to implement the computer program. The computer program may include computer code arranged to instruct a computer to perform the functions of one or more of the various methods described above. The computer program and/or the code for performing such methods may be provided to an apparatus, such as a computer, on a computer readable medium. The computer readable medium could be, for example, an electronic, magnetic, optical, electromagnetic, infrared, or semiconductor system, or a propagation medium for data transmission, for example for downloading the code over the Internet. Non-limiting examples of a physical computer readable medium include semiconductor or solid state memory, magnetic tape, a removable computer diskette, a random access memory (RAM), a read-only memory (ROM), a rigid magnetic disc, and an optical disk, such as a CD-ROM, CD-R/W or DVD.

An apparatus such as a computer may be configured in accordance with such computer code to perform one or more processes in accordance with the various methods discussed above.

It will be appreciated that any of the above-mentioned embodiments may be combined with one another where appropriate. Furthermore, it will be appreciated that the above-described embodiments of the invention are provided as example only and as such the scope of the invention is only limited by the scope of the appended claims.

1. A method for data transmission in a radio data transmission system having a plurality of parallel single-input single-output or multiple-input multiple-output channels over which the data is transmitted, the data represented by a plurality of data symbols, the data symbols being spread prior to transmission by a plurality of spreading sequences, the method comprising:
determining a system value λₖ for each signature sequence k of a plurality of signature sequences K, wherein the system value λₖ is indicative of a signal-to-noise ratio of the associated signature sequence k;
determining a number of signature sequences K* to be used for spreading the data symbols in accordance with the system values λₖ associated with the plurality of signature sequences K;
selecting the signature sequences S to be used to spread the data symbols from the plurality of signature sequences K in accordance with the system values λₖ associated with the plurality of signature sequences K, wherein the number of signature sequences selected corresponds to the determined number of signature sequences K*; and
spreading the data symbols using the selected signature sequences S.

2. The method according to claim 1, wherein the number of sequences K* is determined and the signature sequences S to be used to spread the symbols are selected by:
calculating the mean system value
$${[ {\vec{λ}}_{mean} ]}_{{K}_{best}} = \frac{{\sum }_{k}^{{K}_{best}} {λ}_{k}}{{K}_{best}}$$
for K_{best}=K to K_{best}=1, wherein K_{best} is an initial number of signature sequences utilised for calculating the mean system value └\vec{λ}ₘₑₐₙ┘_{K}_{_{best}}, and wherein each signature sequence is assigned an equal transmission energy Eₖ for calculating the mean system values └\vec{λ}ₘₑₐₙ┘_{K}_{_{best}};
determining the number of signature sequences K* to be used for spreading the data symbols and selecting the signature sequences S to be used to spread the symbols in accordance with the mean system value vector \vec{λ}ₘₑₐₙ, wherein the mean system value vector \vec{λ}ₘₑₐₙ comprises the plurality of mean system values └\vec{λ}ₘₑₐₙ┘_{K}_{_{best}} for K_{best}=1 to K_{best}=K.

3. The method according to claim 2, wherein:
the number of signature sequences K* to be used for spreading the data symbols is determined to be equal to the initial number of signature sequences K_{best} when the following equation is satisfied:
$${λ}^{*} ( {b}_{{p}_{{K}_{best}}} ) \leq {[ {\vec{λ}}_{mean} ]}_{{K}_{best}} < {λ}^{*} ( {b}_{{p}_{{K}_{best}} + 1} ) .$$
for K_{best}=1 to K_{best}=K, wherein └\vec{λ}ₘₑₐₙ┘_{K}_{_{best}} is the mean system value,
$${b}_{{p}_{{K}_{best}}}$$
is a discrete data rate that can be allocated to each data symbol and is chosen from a plurality of data rates from b₁ to bₚ for integer values of p from p=1 to p=P for a plurality of P discrete rates for a target system value λ*(bₚ), the target system value λ*(bₚ) being determined in terms of the data rate bₚ by using the following equation:
$${λ}^{*} ( {b}_{{p}_{k}} ) = \frac{Γ ( {2}^{{b}_{p}} - 1 )}{1 - Γ ( {2}^{{b}_{p}} - 1 )}$$
wherein Γ is the gap value for the modulation scheme; and
the selected signature sequences S are the K* signature sequences of the plurality of signature sequences K having the highest system values λₖ.

4. The method according to claim 1, wherein the number of sequences K* is determined and the signature sequences S to be used to spread the symbols are selected by:
calculating the minimum system value └\vec{λ}ₘᵢₙ┘_{K}_{ₒₚₜ}=min(\vec{λ}) for Kₒₚₜ=K to Kₒₚₜ=1 wherein Kₒₚₜ is an initial number of signature sequences utilised for calculating the minimum system value └\vec{λ}ₘᵢₙ┘_{K}_{ₒₚₜ}, and each signature sequence is assigned an equal transmission energy Eₖ;
determining the number of signature sequences K* and selecting the signature sequences S to be used to spread the data symbols in accordance with the minimum system value vector \vec{λ}ₘᵢₙ comprising a plurality of minimum system values └\vec{λ}ₘᵢₙ┘_{K}_{ₒₚₜ} for Kₒₚₜ K to Kₒₚₜ=1.

5. The method according to claim 4, wherein:
the number of signature sequences K* to be used for spreading the data symbols is determined to be equal to the initial number of signature sequences Kₒₚₜ when the following equation is satisfied:
$${λ}^{*} ( {b}_{{p}_{{K}_{opt}}} ) \leq {[ {\vec{λ}}_{min} ]}_{{K}_{opt}} < {λ}^{*} ( {b}_{{p}_{{K}_{opt}} + 1} ) .$$
for Kₒₚₜ=1 to Kₒₚₜ=K, wherein └\vec{λ}ₘᵢₙ┘_{K}_{ₒₚₜ} is the minimum system value, bₚ_{_{Kopt}} is a discrete data rate that can be allocated to each symbol and is chosen from a plurality of data rates from b₁ bₚ for integer values of p from p=1 to p=P for a plurality of P discrete rates for a target system value λ*(bₚ); and
the selected signature sequences S are the K* signature sequences of the plurality of signature sequences K having the highest system values λₖ .

6. The method according to claim 1, further comprising:
ordering, before selecting the signature sequences S, the plurality of signature sequences K from the signature sequence k of the plurality of signature sequences K having the highest system value λₖ to the signature sequence k of the plurality of signature sequences K having the lowest system value λₖ; wherein
a high system value λₖ is indicative of a high signal-to-noise ratio, and
the selected signature sequences S are the first K* signature sequences of the ordered signature sequence.

7. The method according to claim 1, further comprising:
allocating data rates bₚ_{ₖ} to the plurality of selected signature sequences S in accordance with the system value λₖ wherein the summation of the allocated data rates bₚ_{ₖ} corresponds to a total data rate per symbol period.

8. The method according to claim 7, wherein the data rates bₚ_{ₖ} are allocated when determining the number of signature sequences K*.

9. A method for data transmission in a radio data transmission system having a plurality of parallel single-input single-output or multiple-input multiple-output over which the data is transmitted, the data represented by a plurality of data symbols, the data symbols being spread prior to transmission by a plurality of spreading sequences, the method comprising:
determining a system value λₖ for each signature sequence k of a plurality of signature sequences K, wherein the system value λₖ is indicative of a signal-to-noise ratio of the associated signature sequence k;
determining a number of signature sequences K* to be used for spreading the data symbols in accordance with the system values λₖ associated with the plurality of signature sequences K;
selecting the signature sequences S to be used to spread the data symbols from the plurality of signature sequences K in accordance with the system values λₖ associated with the plurality of signature sequences K, wherein the number of signature sequences selected corresponds to the determined number of signature sequences K*; and
spreading the data symbols using the selected signature sequences S,
further comprising:
allocating data rates bₚ_{ₖ} to the plurality of selected signature sequences S in accordance with the system value λₖ , wherein the summation of the allocated data rates bₚ_{ₖ} corresponds to a total data rate per symbol period,
wherein the number of sequences K* is determined and the signature sequences S to be used to spread the symbols are selected by:
calculating the mean system value
$${[ {\vec{λ}}_{mean} ]}_{{K}_{best}} = \frac{{\sum }_{k}^{{K}_{best}} {λ}_{k}}{{K}_{best}}$$
for K_{best}=K to K_{best}=1, wherein K_{best} is an initial number of signature sequences utilised for calculating the mean system value └\vec{λ}ₘₑₐₙ┘_{K}_{_{best}}, and wherein each signature sequence is assigned an equal transmission energy Eₖ for calculating the mean system values └\vec{λ}ₘₑₐₙ┘_{K}_{_{best}};
determining the number of signature sequences K* to be used for spreading the data symbols and selecting the signature sequences S to be used to spread the symbols in accordance with the mean system value vector \vec{λ}ₘₑₐₙ, wherein the mean system value vector \vec{λ}ₘₑₐₙ comprises the plurality of mean system values └\vec{λ}ₘₑₐₙ┘_{K}_{_{best}} for K_{best}=1 to K_{best}=K.,
wherein the total rate is determined by finding a maximum integer number m_{EE} that satisfies:
$$( {K}^{*} - {m}_{EE} ) {λ}^{*} ( {b}_{{p}_{{K}^{*}}} ) + {m}_{EE} {λ}^{*} ( {b}_{{p}_{{K}^{*}} + 1} ) \leq {{K}^{*} [ {\vec{λ}}_{min} ]}_{{K}^{*}}$$
wherein the first group of signature sequences are (K*−m_{EE}) used to transmit data at a discrete data rate
$${b}_{{p}_{{K}^{*}}}$$
and a second group or signature sequences comprising the remaining m_{EE} signature sequences are used to transmit data at a discrete rate
$${b}_{{p}_{{K}^{*}} + 1}$$
for the case corresponding to equal energy allocation.

10. A method for data transmission in a radio data transmission system having a plurality of parallel single-input single-output or multiple-input multiple-output channels over which the data is transmitted, the data represented by a plurality of data symbols, the data symbols being spread prior to transmission by a plurality of spreading sequences, the method comprising:
determining a system value λₖ for each signature sequence k of a plurality of signature sequences K, wherein the system value λₖ is indicative of a signal-to-noise ratio of the associated signature sequence k;
determining a number of signature sequences K* to be used for spreading the data symbols in accordance with the system values λₖ associated with the plurality of signature sequences K;
selecting the signature sequences S to be used to spread the data symbols from the plurality of signature sequences K in accordance with the system values λₖ associated with the plurality of signature sequences K, wherein the number of signature sequences selected corresponds to the determined number of signature sequences K*; and
spreading the data symbols using the selected signature sequences S.,
further comprising:
allocating data rates bₚ_{ₖ} to the plurality of selected signature sequences S in accordance with the system value λₖ, wherein the summation of the allocated data rates bₚ_{ₖ} corresponds to a total data rate per symbol period,
wherein the number of sequences K* is determined and the signature sequences S to be used to spread the symbols are selected by:
calculating the minimum system value └\vec{λ}ₘᵢₙ┘_{K}_{ₒₚₜ}=min (λ) for Kₒₚₜ=K to Kₒₚₜ=1 wherein Kₒₚₜ is an initial number of signature sequences utilised for calculating the minimum system value └\vec{λ}ₘᵢₙ┘_{K}_{ₒₚₜ}, and each signature sequence an equal transmission energy Eₖ;
determining the number of signature sequences K* and selecting the signature sequences S to be used to spread the data symbols in accordance with the minimum system value vector \vec{λ}ₘᵢₙ comprising a plurality of minimum system values └\vec{λ}ₘᵢₙ┘_{K}_{ₒₚₜ} for Kₒₚₜ=K to Kₒₚₜ=1,
wherein the total rate is determined by finding a maximum integer m_{ES} that satisfies:
$$( {K}^{*} - {m}_{ES} ) {λ}^{*} ( {b}_{{p}_{{K}^{*}}} ) + {m}_{ES} {λ}^{*} ( {b}_{{p}_{{K}^{*}} + 1} ) \leq {K}^{*} {⌊ {\vec{λ}}_{mean} ⌋}_{{K}^{*}}$$
wherein a first group of signature sequences (K*−m_{ES}) are used to transmit data at a discrete data rate bₚ_{_{K*}}, and a second group of signature sequences comprising the remaining m_{ES} signature sequences are used to transmit data at a discrete rate
$${b}_{{p}_{{K}^{*}} + 1} .$$

11. The method according to claim 7, further comprising:
allocating transmission energies to the plurality of selected signature sequences K in accordance with the allocated transmission data rate bₚ_{ₖ} and the corresponding system values λₖ to maximize the total data rate per symbol period for the total transmission energy, wherein the summation of the allocated transmission energies corresponds to a total transmission energy E_{T}.

12. The method according to claim 11, wherein the transmission energies E_{k,i} are determined iteratively with the following equation based upon a receiver without a successive interference cancellation, SIC, scheme wherein the mean system value is used to determine the number of signature sequences K*:
$${E}_{k , i} = \frac{{λ}^{*} ( {b}_{{p}_{{K}^{*}}} )}{{\vec{q}}_{k}^{H} {C}_{i - 1}^{- 1} {\vec{q}}_{k}}$$
wherein i is the iteration number Cᵢ₋₁⁻¹ is an inverse covariance matrix which is determined by inverting covariance matrix Cᵢ₋₁, wherein the covariance matrix Cᵢ₋₁ is expressed in terms of an extended matched filter signature sequence matrix Qₑ and an extended amplitude matrix A_{e,(i-1)}I, [symbol] A₍ᵢ₋₁₎ using the following equation Cᵢ₋₁=Qₑ₍ᵢ₋₁₎²Qₑ^{H}+2σ²I_{N}_{_{R}}_{(N+l-1)}, wherein [symbol] is the kronecker product and the amplitude matrix A₍ᵢ₋₁₎=diag└\sqrt{E_{1,(i-1)}}, \sqrt{E_{2,(i-1)}}, . . . , \sqrt{E_{K*,(i-1)}}┘ is expressed in terms of transmission energies, wherein 2σ² is the noise variance, N_{R} is the number of receiver antennas, N is the processing gain, L is the multipath delay spread length, wherein the extended matched filter receiver sequence matrix Qₑ is expressed in accordance with the following equation Qₑ=[Q, Q₁, Q₂], wherein Q₁ represents the matched filter sequences for the previous symbol period and Q₂ represents the matched filter sequences for the next symbol period, and Q₁ and Q₂ are expressed in accordance with Q₁=└I_{N}_{_{R}} [symbol] (J_{N+L-1}^{T})^{N}┘Q=[\vec{q}_{1,1}, . . . , \vec{q}_{k,1}, . . . , \vec{q}_{K*,1}] and Q₂=[I_{N}_{_{R}} [symbol] J_{N+L-1}^{N}]Q=└\vec{q}_{1,2}, . . . , \vec{q}_{k,2}, . . . , \vec{q}_{K*,2}┘ wherein a \vec{q}_{k,1} and \vec{q}_{k,2} are the ISI matched filter sequences for the previous and next symbol periods of the number of signature sequences K*, wherein
$${J}_{N + L - 1} = [ \begin{matrix}{\vec{0}}_{( N + L - 2 )}^{T} & 0 \\ {I}_{N + L - 2} & {\vec{0}}_{N + L - 2}\end{matrix} ]$$
is the shift matrix, wherein the matched filter despreading signature sequence matrix Q=└\vec{q}₁, . . . , \vec{q}ₖ, . . . , \vec{q}_{K}, ┘ is determined with the following equation Q=HS , wherein \vec{q}ₖ is the matched filter receiver despreading signature sequence for a plurality of transmission signature sequences S=└\vec{s}₁, . . . , \vec{s}ₖ, . . . , \vec{s}_{K*}┘ of length N wherein H is the MIMO system convolution matrix for a frequency selective multipath channel, wherein the convolution matrix H is expressed in accordance with the following equation
$$H = [ \begin{matrix}{H}^{( 1 , 1 )} & … & {H}^{( 1 , {N}_{T} )} \\ ⋮ & … & ⋮ \\ {H}^{( {N}_{R} , 1 )} & … & {N}^{( {N}_{R} , {N}_{T} )}\end{matrix} ] ,$$
wherein N_{T} is the total number of transmitter antennas, the channel convolution matrix H⁽ⁿ^{ᵣ}^{,n}^{ₜ}⁾ between each pair of receiver antenna 11, and transmitter antenna nₜ with channel impulse response vector \vec{h}⁽ⁿ^{ᵣ}^{,n}^{ₜ}⁾=[h₀⁽ⁿ^{ᵣ}^{,n}^{ₜ}⁾, . . . , h_{L-1}⁽ⁿ^{ᵣ}^{,n}^{ₜ}⁾] is expressed in terms of the following equation
$${H}^{( {n}_{r} , {n}_{t} )} = [ \begin{matrix}{\vec{h}}^{( {n}_{r} , {n}_{t} )} & 0 & … & 0 \\ 0 & {\vec{h}}^{( {n}_{r} , {n}_{t} )} & … & ⋮ \\ ⋮ & … & ⋱ & 0 \\ 0 & 0 & … & {\vec{h}}^{( {n}_{r} , {n}_{t} )}\end{matrix} ] .$$

13. The method according to claim 11, wherein the transmission energies E_{k,i} are determined iteratively by solving the following equation based upon a receiver with a successive interference cancellation, SIC, scheme wherein the mean system value is used to determine the number of signature sequences K*:
$${E}_{k , i} = \frac{{γ}^{*} ( {b}_{{p}_{k}} )}{\begin{matrix}ξ - \frac{{E}_{k , ( i - 1 )} {\vert {ξ}_{3} \vert}^{2}}{1 + {E}_{k , ( i - 1 )} {ξ}_{l}} - \\ \frac{{E}_{k , ( i - 1 )} ( {\vert {ξ}_{4} \vert}^{2} - 2 \frac{{E}_{k , ( i - 1 )}}{1 + {E}_{k , ( i - 1 )} {ξ}_{1}} {ξ}_{6} + {( \frac{{E}_{k , ( i - 1 )}}{1 + {E}_{k , ( i - 1 )} {ξ}_{1}} )}^{2} {\vert {ξ}_{5} \vert}^{2} {\vert {ξ}_{3} \vert}^{2} )}{1 + {E}_{k} ( {ξ}_{2} - \frac{{E}_{k , ( i - 1 )}}{1 + {E}_{k , ( i - 1 )} {ξ}_{1}} {\vert {ξ}_{5} \vert}^{2} )}\end{matrix}}$$
for a given inverse covariance matrix Cₖ₋₁⁻¹ wherein the inverse matrix Cₖ₋₁⁻¹ is the inverse of the covariance matrix Cₖ₋₁ wherein the covariance matrix Cₖ₋₁ is iteratively determined by solving the following equation:
CₖCₖ₋₁Eₖ\vec{q}ₖ\vec{q}ₖ^{H}+Eₖ\vec{q}_{k,1}\vec{q}_{k,1}^{H}+Eₖ\vec{q}_{k,2}\vec{q}_{k,2}^{H}
for k=1, . . . , K* when using C₀=2σ²I_{N}_{_{R}}_{(N+L-1)}, wherein the target SNR γ*(bₚ_{ₖ}) is determined by using the following equation:
$${γ}_{k}^{*} ( {b}_{{p}_{k}} ) = Γ ( {2}^{{b}_{{p}_{k}}} - 1 ) ,$$
the weighting factors ξ, ξ₁, ξ₂, ξ₃, ξ₄, ξ₅, and ξ₆ are constructed from the SIC receiver covariance matrix Cₖ₋₁⁻¹ and \vec{q}ₖ, \vec{q}_{k,1} and \vec{q}_{k,2} using
ξ=\vec{q}ₖ^{H}\vec{d}, ξ₁=\vec{q}_{k,1}^{H}\vec{d}₁, ξ₂=\vec{q}_{k,2}^{H}\vec{d}₂,
ξ₃=\vec{q}ₖ^{H}\vec{d}₁, ξ₄=\vec{q}ₖ^{H}\vec{d}₂, ξ₅=\vec{q}_{k,1}^{H}\vec{d}₂, ξ₆=Real(ξ₃ξ*₄ξ₅);
wherein the distance vectors \vec{d}, \vec{d}₁, \vec{d}₂ are determined using the following equations
\vec{d}=Cₖ₋₁⁻¹\vec{q}ₖ, \vec{d}₁=Cₖ₋₁⁻¹\vec{q}_{k,1}, \vec{d}₂=Cₖ₋₁⁻¹\vec{q}_{k,2}.

14. The method according to claim 13, wherein for an inverse covariance matrix Cₖ₋₁⁻¹ with
$${C}_{0}^{- 1} = \frac{1}{2 {σ}^{2}} {I}_{{N}_{R} ( N + L - 1 )} ,$$
and also for an energy allocation Eₖ and a set of MIMO system parameters with \vec{q}ₖ, \vec{q}_{k,1} and \vec{q}_{k,2}, Eₖ, Eₖ, σ², the inverse covariance matrix Cₖ⁻¹ is constructed for k=1 , . . . , K* starting at k=1 using the inverse covariance matrix Cₖ₋₁⁻and the energy Eₖ by:
determining the distance vectors, \vec{d}, \vec{d}₁ and \vec{d}₂;
determining the weighting factors ξ, ξ₁, ξ₂, ξ₃, ξ₄, ξ₅, and ξ₆, and
determining the weighted energy terms ζ₁, and ζ₂ by using the allocated energy Eₖ for k=1, . . . , K* in the following equations:
$${ζ}_{1} = \frac{{E}_{k}}{1 + {E}_{k} {ξ}_{1}} , {ζ}_{2} = \frac{{E}_{k}}{1 + {E}_{k} ( {ξ}_{2} - {ζ}_{1} {\vert {ξ}_{5} \vert}^{2} )} ;$$
determining the interim matrices Z₁, Z₂, Z₃ by solving the following equations:
Z₁=\vec{d}₁\vec{d}₁^{H}, Z₂=\vec{d}₂\vec{d}₂^{H}, Z₃=\vec{d}₁\vec{d}₂^{H};
determining the inverse reduced covariance matrix Dₖ⁻¹ by solving the following equation:
Dₖ⁻¹=Cₖ₋₁⁻¹−(ζ₁²ζ₂|ξ₅|²+ζ₁)Z₁−ζ₂Z₂+ζ₁ζ₂(ξ₅Z₃+ξ*₅Z₃^{H}); and
constructing the inverse of the covariance matrix Cₖ⁻¹ by using the following equation:
Cₖ⁻¹=Dₖ⁻¹−ζZ₄;
wherein the weighted energy term C is determined by solving the following equation:
$$ζ = \frac{{E}_{k}}{1 + {E}_{k} ( \begin{matrix}ξ - \frac{{E}_{k} {\vert {ξ}_{3} \vert}^{2}}{1 + {E}_{k} {ξ}_{l}} - \\ \frac{{E}_{k} ( {\vert {ξ}_{4} \vert}^{2} - 2 \frac{{E}_{k}}{1 + {E}_{k} {ξ}_{1}} {ξ}_{6} + {( \frac{{E}_{k}}{1 + {E}_{k} {ξ}_{1}} )}^{2} {\vert {ξ}_{5} \vert}^{2} {\vert {ξ}_{3} \vert}^{2} )}{1 + {E}_{k} ( {ξ}_{2} - \frac{{E}_{k}}{1 + {E}_{k} {ξ}_{1}} {\vert {ξ}_{5} \vert}^{2} )}\end{matrix} )} , ;$$
wherein the interim matrix Z₄ is determined by using the following equation:
Z₄=\vec{d}₃\vec{d}₃^{H}; and
wherein the distance vector \vec{d}₃ is determined using the following equation:
\vec{d}₃=Dₖ⁻¹\vec{q}ₖ.

15. The method according to claim 1, wherein the number of signature sequences K* is determined and the signature sequences S to be used to spread the data are selected using an iterative water-filling based continuous bit loading method comprising:
determining the number of signature sequences K* by determining the total number of signature sequences that maximize the total data rate b_{T,K}.

16. The method according to claim 15, wherein for a plurality of matched filter signature sequences \vec{q}ₖ, \vec{q}_{k,1} and \vec{q}_{k,2}, the iterative water-filling optimisation method further comprises:
setting an initial number of signature sequences Kₒₚₜ;
determining the system values λₖ associated with the initial number of signature sequences Kₒₚₜ;
determining a channel SNR vector \vec{g} using the following equation
$${[ \vec{g} ]}_{k} = \frac{{λ}_{k}}{{E}_{k} ( 1 - {λ}_{k} )} ;$$
for an energy allocation Eₖ;
determining a water filling constant K_{WF} using the following equation:
$${K}_{WF} = \frac{1}{{K}_{opt}} ( {E}_{T} + Γ {\sum }_{k = 1}^{{K}_{opt}} \frac{1}{{[ \vec{g} ]}_{k}} ) ;$$
wherein E_{T} is a total transmission energy;
determining energies Eₖ to be allocated to each signature sequence k of the plurality of signature sequences K by using the following equation:
$${E}_{k} = {K}_{WF} - \frac{Γ}{{[ \vec{g} ]}_{k}}$$
reordering the matched filter signature sequences \vec{q}ₖ, \vec{q}_{k,1} and \vec{q}_{k,2} in accordance with the system values └\vec{λ}┘ₖ=λₖ associated with the initial number of signature sequences Kₒₚₜ in an ascending order to provide an ordered list of matched filter signature sequences;
deleting the first matched filter sequences \vec{q}₁, \vec{q}_{1,1} and \vec{q}_{1,2} of the ordered list of matched filter signature sequences; and
setting Kₒₚₜ=Kₒₚₜ−1 if the allocated energy Eₗis negative;
repeating the above steps;
determining a total number of bits b_{T,K} to be transmitted by using
$${b}_{T , K} = {\sum }_{k = 1}^{{K}_{opt}} {log}_{2} ( 1 + \frac{{λ}_{k}}{Γ ( 1 - {λ}_{k} )} ) ;$$
determining the number of signature sequences K* of the plurality of signature sequences K under consideration by using K*=Kₒₚₜ.

17. The method according to claim 16, wherein the iterative water filling method determines the number of signature sequences K* by:
initially setting the total number of signature sequences K*=K;
determining a total data rate to be transmitted and the number of signature sequences K* for values of K*=K−1 until the number of signature sequences K* reaches the value K*=1; and
selecting the number of signature sequences K* for the plurality of signature sequences K which maximises the total data rate.

18. The method according to claim 1, wherein the system value is determined by the following equation:
λₖ=γₖεₖ
wherein γₖ is the signal-to-noise ratio at an output of a de-spreading unit of an MMSE receiver, and εₖ is the mean-square-error at the output of the de-spreading unit, the mean-square-error relating to the system value by λₖ=1−εₖ .

19. The method according to either claim1 or claim 14, wherein the system value λₖ is determined in accordance with the following equation based upon a receiver without a successive interference cancelling, SIC, scheme:
λₖ=Eₖ\vec{q}ₖ^{H}C⁻\vec{q}ₖ
wherein C is expressed in terms of the extended matched filter signature sequence matrix Qₑ and the extended amplitude matrix Aₑ=I [symbol] A using the following equation C=QₑAₑ²Qₑ^{H}+2σ²I_{N}_{_{R}}_{(N+l-1)} wherein [symbol] is the kronecker product and the amplitude matrix A=diag[\sqrt{E₁}, \sqrt{E₂}, . . . , \sqrt{E_{K*}}], wherein the matched filter despreading signature sequence matrix Q=└\vec{q}₁, . . . , \vec{q}ₖ, . . . , \vec{q}_{K*}┘ is formed to construct the extended matched filter signature sequence matrix Qₑ by using the following equation Qₑ=[Q, Q₁, Q₂], wherein Q₁ represents the matched filter sequences for the previous symbol period and Q₂ represents the matched filter sequences for the next symbol period, wherein Q₁ and Q₂ are expressed in accordance with the following equations Q₁=└I_{N}_{_{R}} [symbol] (J_{N+L-1}^{T})^{N}┘Q=[\vec{q}_{1,1}, . . . , \vec{q}_{k,1}, . . . , \vec{q}_{K*,1}] and Q₂=[I_{N}_{_{R}} [symbol] J_{N+L-1}^{N}]Q=└\vec{q}_{1,2}. . . , \vec{q}_{k,2}, . . . \vec{q}_{K*,2}┘, wherein \vec{q}_{k,1} and \vec{q}_{k,2} are the ISI matched filter sequences for the previous and next symbol periods.

20. The method according to either claim 1 or claim 12, wherein the system value λₖ is determined in accordance with the following equation based upon a receiver having a successive interference cancelling, SIC, scheme:
λₖ=Eₖ\vec{q}ₖ^{H}Cₖ⁻¹\vec{q}ₖ
wherein Cₖ₋₁ is a covariance matrix which is iteratively determined by solving the following equation:
Cₖ=Cₖ₋₁+Eₖ\vec{q}ₖ\vec{q}ₖ^{H}+Eₖ\vec{q}_{k,1}\vec{q}_{k,1}^{H}+Eₖ_{_{\vec{q}}}_{k,2}\vec{q}_{k,2}^{H}
for k=1, . . ., K* when using C₀=2σ²I_{N}_{(N+L-1)} wherein \vec{q}_{k,1} and \vec{q}_{k,2} are the ISI matched filter sequences for the previous and next symbol periods and \vec{q}ₖ is the matched filter despreading signature sequence.

21. Apparatus arranged to perform the method of claim 1.

22. (canceled)

23. A computer readable medium implementable on a computer and operable, in use, to perform the method of claim 1.
